(19) United States
(12) Patent Application Publication
(10) Pub. No.: US 2013/0124240 A1
(43) Pub. Date: May 16, 2013

(54) System and Method for Student Activity Gathering in a University

(71) Applicants: Sridhar Varadarajan, Bangalore (IN); Preethy Iyer, Bangalore (IN); Meera Divya Munipalli Venugopal, Banglore (IN)

(72) Inventors: Sridhar Varadarajan, Bangalore (IN); Preethy Iyer, Bangalore (IN); Meera Divya Munipalli Venugopal, Banglore (IN)

(73) Assignee: SRM INSTITUTE OF TECHNOLOGY, Chennai (IN)

(21) Appl. No.: 13/405,017

(22) Filed: Feb. 24, 2012

(30) Foreign Application Priority Data
Nov. 14, 2011 (IN) 3905/CHE/2011

(51) Int. Cl. G06Q 10/00

(52) U.S. Cl. 705/7.11

(57) ABSTRACT

An educational institution (also referred as a university) is structurally modeled using a university model graph. A key benefit of modeling of the educational institution is to help in an introspective analysis by the educational institute. In order to build an effective university model graph, it is required to gather and analyze the various activities performed on the university campus by the various entities of the university. A system and method for automated activity gathering that involves instrumented components, sub-systems, and networks is discussed. Specifically, the presented system allows for reliable identification of activities performed by a student of the university based on inputs received from multiple sources associated with the instrumented components, sub-systems, and networks.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” with an application number 1809/CHE/2010 and filing date of 28 Jun. 2010.

3. A reference is made to yet another of the applicants' earlier Indian patent application titled “System and Method for University Model Graph based Visualization” with the application number 1848/CHE/2010 dated 30 Jun. 2010.

4. A reference is made to yet another of the applicants' earlier Indian patent application titled “System and method for what-if analysis of a university based on university model graph” with the application number 3203/CHE/2010 dated 28 Oct. 2010.

5. A reference is made to yet another of the applicants' earlier Indian patent application titled “System and method for comparing universities based on their university model graphs” with the application number 3492/CHE/2010 dated 22 Nov. 2010.

6. A reference is made to the applicants' Copyright document “Activity and Interaction based Holistic Student Modeling in a University: ARIEL UNIVERSITY STUDENT Process Document” that has been forwarded to the Registrar of Copyrights Office, New Delhi.

### FIELD OF THE INVENTION

The present invention relates to the analysis of the information about a university in general, and more particularly, the analysis of the activities of the university associated with structural representations. Still more particularly, the present invention relates to a system and method for automatic gathering of activities associated with the university.

### BACKGROUND OF THE INVENTION

An Educational Institution (EI) (also referred as University) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n)

Information Resources. The educational institutions are positioned in a very competitive environment and it is a constant endeavor of the management of the educational institution to ensure to be ahead of the competition. This calls for a critical analysis of the overall functioning of the university and help suggest improvements so as enhance the overall strength aspects and overcome the weaknesses. Consider a typical scenario of assessing of a student of the Educational Institution. In order to achieve a holistic assessment, it is required to assess the student not only based on the curricular activities but also those other but related activities. This requires the gathering of the activities of the student and to use them appropriately in the holistic assessment process.

### DESCRIPTION OF RELATED ART

U.S. Pat. No. 7,987,070 to Kahn; Philippe (Aptos, Calif.), Kinsolving; Arthur (Santa Cruz, Calif.), Christensen; Mark Andrew (Santa Cruz, Calif.), Lee; Brian Y. (Aptos, Calif.), Vogel; David (Santa Cruz, Calif.) for “Eyewear having human activity monitoring device” (issued on Jul. 26, 2011 and assigned to DP Technologies, Inc. (Scotts Valley, Calif.)) describes a method for monitoring human activity using an inertial sensor that includes obtaining acceleration measurement data from an inertial sensor disposed in eyewear.

U.S. Pat. No. 7,982,609 to Padmanabhan; Venkata (Bangalore, Ind.), Sivalingam; Lenin Ravindranath (Cambridge, Mass.), Agrawal; Piyush (Stanford, Calif.) for “RFID-based enterprise intelligence” (issued on Jul. 19, 2011 and assigned to Microsoft Corporation (Redmond, Wash.)) describes an “RFID-Based Inference Platform” that provides various techniques for using RFID tags in combination with other enterprise sensors to track users and objects, infer their interactions, and provide these inferences for enabling further applications.

U.S. Pat. No. 7,962,312 to Darley; Jesse (Madison, Wis.), Blackadar; Thomas P. (Norwalk, Conn.) for “Monitoring activity of a user in locomotion on foot” (issued on Jun. 14, 2011 and assigned to Nike, Inc. (Beaverton, Oreg.)) describes a method that involves using at least one device supported by a user while the user is in locomotion on foot during an outing to automatically measure amounts of time taken by the user to complete respective distance intervals.

U.S. Pat. No. 7,881,902 to Kahn; Philippe (Aptos, Calif.), Kinsolving; Arthur (Santa Cruz, Calif.), Christensen; Mark Andrew (Santa Cruz, Calif.), Lee; Brian Y. (Aptos, Calif.), Vogel; David (Santa Cruz, Calif.) for “Human activity monitoring device” (issued on Feb. 1, 2011 and assigned to DP Technologies, Inc. (Scotts Valley, Calif.)) describes a method for monitoring human activity using an inertial sensor that includes continuously determining an orientation of the inertial sensor, assigning a dominant axis, updating the dominant axis as the orientation of the inertial sensor changes, and counting periodic human motions by monitoring accelerations relative to the dominant axis.

U.S. Pat. No. 7,772,965 to Farhan; Fariborz M. (Alphretta, Ga.), Peifer; John W. (Atlanta, Ga.) for “Remote wellness monitoring system with universally accessible interface” (issued on Aug. 10, 2010) describes a remote wellness monitoring system with universally accessible interface for use by people with disabilities and further monitor wellness activity of the care recipient by pegging the number of times the care recipient passes by an infra-red motion sensor.

U.S. Pat. No. 7,617,167 to Griffis; Andrew J. (Tucson, Ariz.), Undhagen; Roger Karl Mikael (Tucson, Ariz.), Acharya; Tinku (Chandler, Ariz.) for “Machine vision system for enterprise management” (issued on Nov. 10, 2009 and assigned to Avisere, Inc. (Tucson, Ariz.)) describes a system for use in managing activity of interest within an enterprise.

U.S. Pat. No. 7,589,637 to Bischoff; Brian J. (Red Wing, Minn.), Shilepsky; Alan P. (Minneapolis, Minn.), Long; Lina (St. Paul, Minn.) for “Monitoring activity of an individual” (issued on Sep. 15, 2009 and assigned to Healthsense, Inc. (Mendoln Heights, Minn.)) describes a method to monitor activities that includes monitoring the activity of an individual including detecting a sensor activated by an individual during the individual's daily activities.

U.S. Pat. No. 7,450,002 to Choi; Ji-hyun (Seoul, KR), Shin; Kun-soo (Seongnam-si, KR), Hwang; Jin-sang (Suwon-si, KR), Hwang; Hyun-tai (Yongin-si, KR), Han; Wan-taek (Hwasgong-si, KR) for “Method and apparatus for monitoring human activity pattern” (issued on Nov. 11, 2008 and assigned to Samsung Electronics Co., Ltd. (Suwon-si, KR)) describes a method and apparatus for monitoring a human activity pattern irrespective of the wearing position of the sensor unit by a user and a direction of the sensor unit.

U.S. Pat. No. 7,421,369 to Clarkson; Brian (Tokyo, JP) for “Activity recognition apparatus, method and program” (issued on Sep. 2, 2008 and assigned to Sony Corporation (Tokyo, JP)) describes an activity recognition apparatus for detecting an activity of a subject based on a sensor unit consisting of multiple sensors.

U.S. Pat. No. 7,103,848 to Barsness; Eric Lawrence (Pine Island, Minn.), Santosuosso; John Matthew (Rochester, Minn.) for “Handheld electronic book reader with annotation and usage tracking capabilities” (issued on Sep. 5, 2006 and assigned to International Business Machines Corporation (Armonk, N.Y.)) describes a method incorporated in a handheld electronic book reader that provides enhanced annotation and usage tracking capabilities.

“Your Noise is My Command: Sensing Gestures Using the Body as an Antenna” by Cohn; Gabe, Morris; Dan, Patel; Shwetak N., Tan; Desney S. (appeared in the Proceedings of CHI 2011, May 7-12, 2011, Vancouver, BC, Canada) describes the use of human body as a receiving antenna and leverage the electromagnetic noise prevalent in home environments for gestural interaction.

“Supporting Hand Gesture Manipulation of Projected Content with Mobile Phones” by Baldauf; Matthias and Frohlich; Peter (appeared in Proceedings of The Fourth Mobile Interaction with the Real World (MIRW) workshop, 11th International Conference on Human-Computer Interaction with Mobile Devices and Services (MobileHCl09) Sep. 15-18, 2009, Germany) describes a framework for spotting hand gestures that is based on a mobile phone, its built-in camera and an attached mobile projector as medium for visual feedback.

“Learning 2.0: The Impact of Web 2.0 Innovations on Education and Training in Europe” by Redecker; Christine, Ala-Mutka; Kirsti, Bacigalupo; Margherita, Ferrari; Anusca, and Punie, Yves (appeared as Final Report, JRC European Commission, 2009) describes how the emergence of new technologies can foster the development of innovative practices in the Education and Training domain.

“SixthSense: RFID-based Enterprise Intelligence” by Ravindranath; Lenin, Padmanabhan; Venkata N., and Agrawal; Piyush (appeared in Proceedings of MobiSys '08, Jun. 17-20, 2008, Breckenridge, Colo., USA) describes a platform for RFID-based enterprise intelligence systems.

The known systems do not address the issue of student activity gathering in the university context. The present invention provides for a system and method for capturing of the well-defined activities of students in a university so as to be of assistance in the holistic assessment of the students.

### SUMMARY OF THE INVENTION

The primary objective of the invention is to gather activities of students within the university campus leading a holistic assessment of the students.

One aspect of the invention is to gather student activities in the various locations within the University campus including auditorium, cafeteria, classroom, conference-room, department, faculty-room, lab, library, social-activity location, sports-field, and study-room.

Another aspect of the invention is to process information including voice, image, script (writing on a tablet using stylus), and text of a student using student-specific voice, image, script, and text processing subsystems.

Yet another aspect of the invention is to process tag information from sources including RFID and Barcode.

Another aspect of the invention is to process information of a student related to collaborations with persons including other students and faculty members using student-specific collaborating sub-system.

Yet another aspect of the invention is to monitor and log the interaction of the student with an any tablet phone device (ATP).

Another aspect of the invention is to gather activities of the student based on the processing of the student information subsystem.

Yet another aspect of the invention is to centrally process voice, image, text, access information, tag information, pulse-data information, collaborating information, logs related to the students of the university.

Another aspect of the invention is to interface with the university information system including university voice sub-system, university email sub-system, university messaging sub-system, university chat sub-system, university blog sub-system, university collaboration sub-system, university department sub-system, university library sub-system, university lab sub-system, university sports sub-system, university cultural sub-system, and university social sub-system.

Yet another aspect of the invention is to generate triggers based on the gathered student activity related information.

Another aspect of the invention is to identify activities based on the generated triggers.

In a preferred embodiment, the present invention provides a system for automatically gathering a plurality of activities of a student of a university in a plurality of locations related to said university based on a plurality of triggers, a plurality of events, a plurality of active components, and a plurality of support information systems,

said plurality of activities being related to said university,

said plurality of locations comprising an auditorium, a cafeteria, a classroom, a conference-room, a department, a faculty-room, a lab, a library, a social-activity-location, a sports-field, and a study-room,

said plurality of active components comprising an any tablet phone (ATP), a plurality of radio frequency identifier (RFID) readers, a plurality of cameras, a plurality of access card readers, a plurality of special bands, and a plurality of RFID tags, wherein said any tablet phone is associated with said student and comprising

a Student Voice Capture and Processing Sub-System for customized processing of voice data of said student,

a Student Image Capture and Processing Sub-System for customized processing of facial expression data of said student,

a Student Script Capture and Processing Sub-System for customized processing of handwritten data of said student,

a Student Text Processing Sub-System for processing of textual data associated with said student,

a Tag Processing Sub-System,

a Student-Specific Collaborating Sub-System,

a Student Interactivity Monitoring Sub-System, and

an ATP Logging Sub-System,

said ATP is in one of a plurality of modes, wherein said plurality of modes comprising a curricular mode, a co-curricular mode, and an extra-curricular mode, and

said plurality of support information systems comprising

a University Voice Sub-System,

a University Email Sub-System,

a University Messaging Sub-System,

a University Chat Sub-System,

a University Blog Sub-System,

a University Collaboration Sub-System,

a University Department Sub-System,

a University Library Sub-System,

a University Lab Sub-System,

a University Sports Sub-System,

a University Cultural Sub-System, and

a University Social Sub-System,

said system comprises
a Generator (420) for generating of said plurality of triggers based on said plurality of active components and said plurality of support information systems;
an Event Determining Sub-System (484) for determining of said plurality of events based on said plurality of triggers; and
an Activity Identification Sub-System (486) for identifying of said plurality of activities based on said plurality of events.

### BRIEF DESCRIPTION OF THE DRAWINGS

FIG. 1 provides a typical assessment of a university.

FIG. 1A provides a partial list of entities of a university.

FIG. 2 provides a typical list of student-related processes.

FIG. 3 provides network architecture of Atiha Grok system.

FIG. 3A provides a typical list of active components of Atiha Grok System.

FIG. 3B provides a typical list of support information systems.

FIG. 3C provides a typical list of student locations.

FIG. 4 provides an overview of Any Tablet Phone (ATP) System.

FIG. 4A depicts an overview of Atiha Grok System and University Information System.

FIG. 5 provides a list of activities related to student processes.

FIG. 5A provides activities related to additional student processes.

FIG. 6 describes detection mechanism of activities.

FIG. 6A describes detection mechanism of additional activities.

FIG. 6B describes detection mechanism of some more activities.

FIG. 7 provides a list of triggers.

FIG. 7A provides a list of additional triggers.

FIG. 7B provides a description of the generation of triggers.

FIG. 7C provides a description of the generation of additional triggers.

FIG. 8 provides an approach for collection of events.

FIG. 8A provides an approach for collection of additional events.

FIG. 8B provides an approach for collection of some more events.

FIG. 9 depicts detailing of activities.

FIG. 10 provides the detection of possible activities based on events.

FIG. 10A provides the detection possible activities based on additional events.

FIG. 10B provides the detection of possible activities based on some more events.

FIG. 10C provides the detection of possible activities based on some more additional events.

### DETAILED DESCRIPTION OF THE PREFERRED EMBODIMENTS

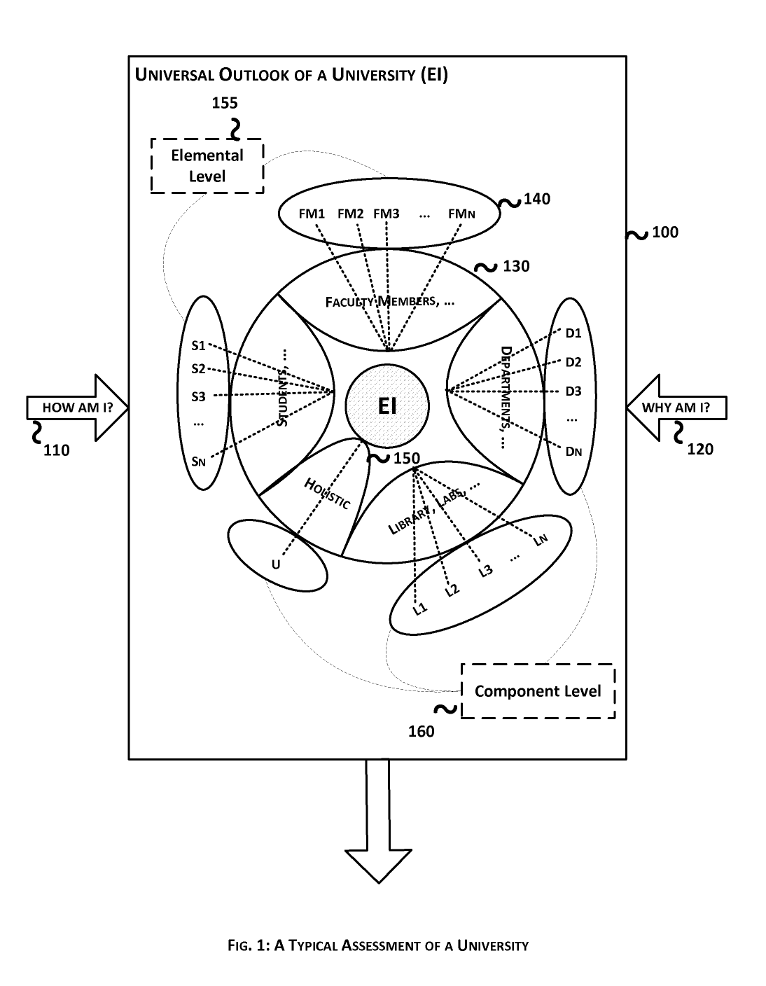

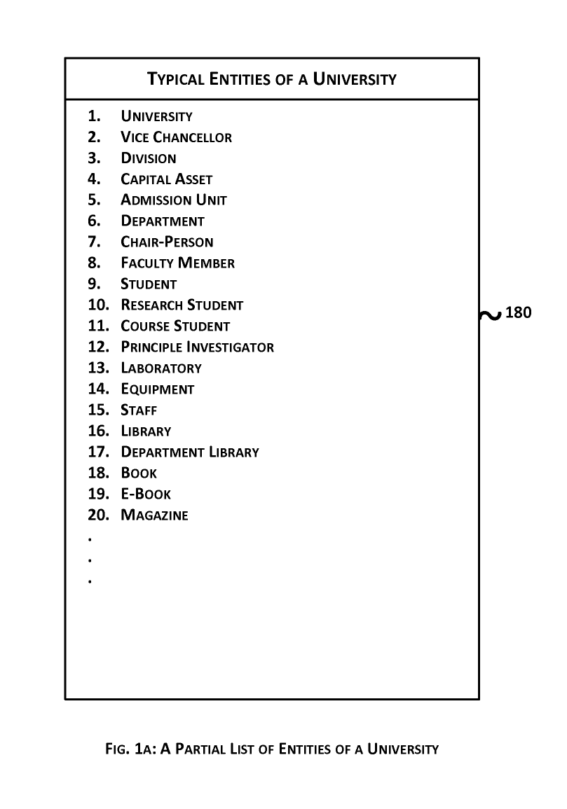

FIG. 1 provides a typical assessment of a university. An Educational Institution (EI) or alternatively, a university, is a complex and dynamic system with multiple entities and each interacting with multiple of other entities. The overall characterization of the EI is based on a graph that depicts these multi-entities multiple relationships. An important utility of such a characterization is to assess the state and status of the EI. What it means is that, in the context of the EI, it is helpful if every of the entities of the EI can be assessed. Assessment of the EI as a whole and the constituents at an appropriate level gives an opportunity to answer the questions such as “How am I?” and “Why am I?”. That is, the assessment of each of the entities and an explanation of the same can be provided. Consider a STUDENT entity: This is one of the important entities of the EI and in any EI there are several instances of this entity that are associated with the students of the EI. The assessment can be at

STUDENT level or at 51 (a particular student) level. 100 depicts the so-called “Universal Outlook of a University” and a system that provides such a universal outlook is capable of addressing “How am I?” (110) and “Why am I?” (120) queries. The FACULTY MEMBER entity (130) characterizes the set of all faculty members of FM1, FM2, . . . , FMn (140) of the EI. The holistic assessment (150) helps answer How and Why at university level. Observe that there are two distinct kinds of entities: One class of entities is at the so-called “Element” level (155)—this means that this kind of entities is at the atomic level as for as the university domain is concerned. On the other hand, there is a second class of entities at the so-called “Component” level (160) that accounts for remaining entities of the university domain all the way up to the University level. It is essential to gather the various activities of a student on the university campus in order to achieve a holistic assessment of STUDENT entity.

FIG. 1A depicts a partial list of entities of a university. Note that a deep domain analysis would uncover several more entities and also their relationship with the other entities (180). For example, RESEARCH STUDENT is a STUDENT who is a part of a DEPARTMENT and works with a FACULTY MEMBER in a LABORATORY using some EQUIPMENT, the DEPARTMENT LIBRARY, and the LIBRARY.

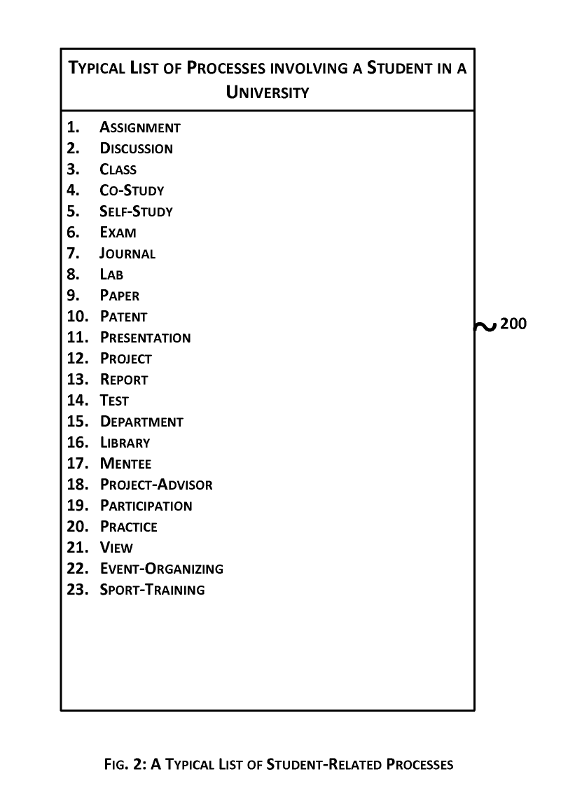

FIG. 2 provides a typical list of student-related processes. This list is arrived based on the deep domain analysis of a university and is from the point of view of STUDENT entity. Specifically, this list categorizes the various activities performed by a typical student within a university. Note that the holistic analysis of a student involves how these activities are performed by the student: for example, a typical behavior of the student in a classroom provides for certain characteristics of the student from the assessment point of view; similarly is the case of the student making a presentation.

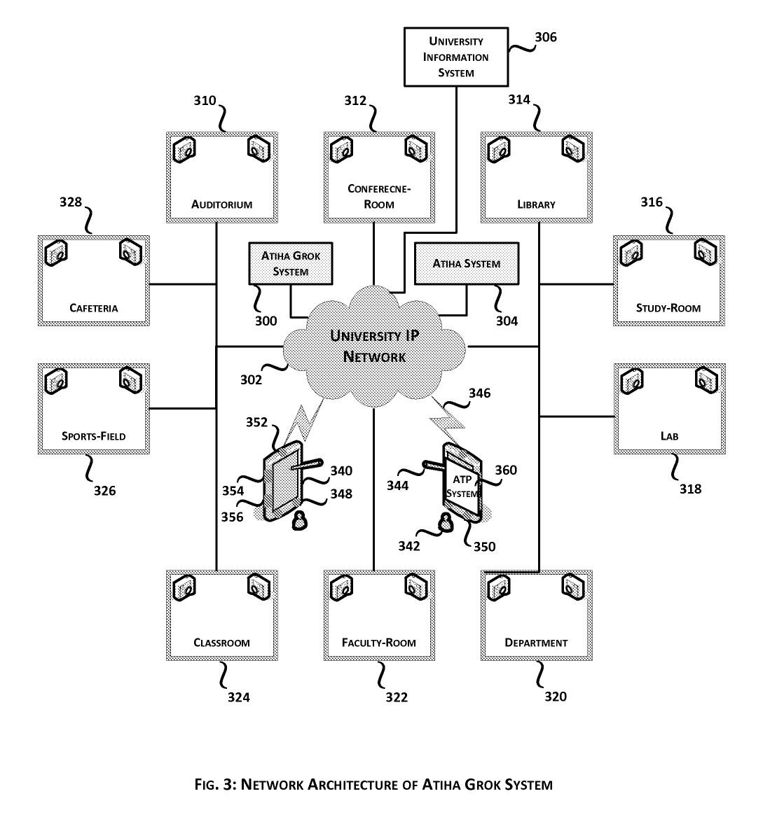

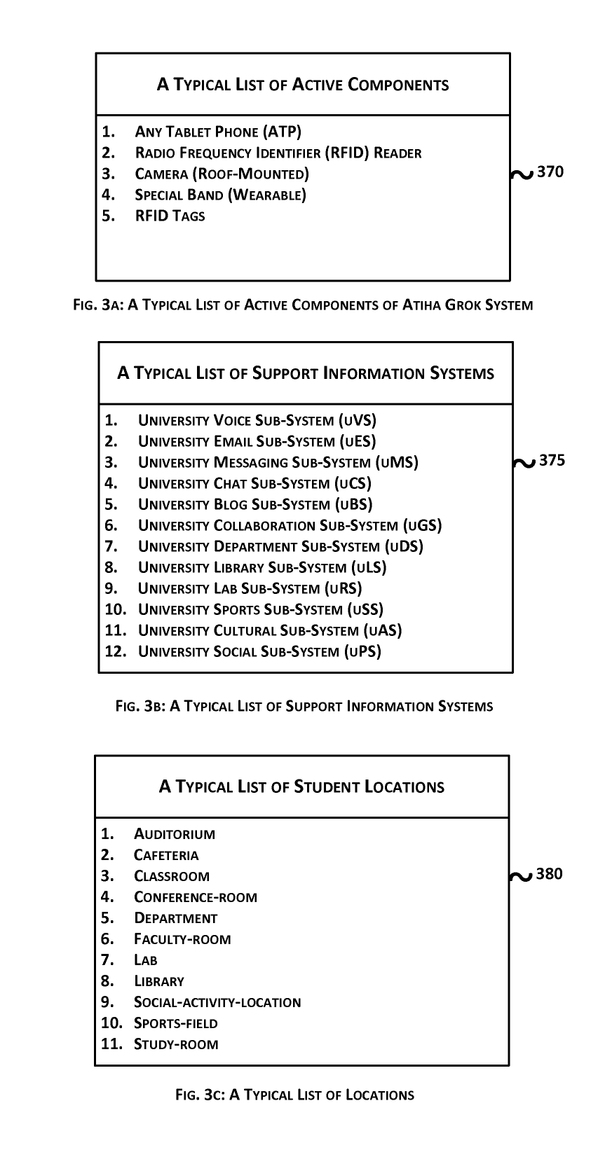

FIG. 3 provides network architecture of Atiha (also referred as “Ariel”) Grok system. Atiha Grok System (300) is connected through the University IP network (302) to the Atiha System (304) and the University Information System (306). While the main objective of the Atiha Grok System is to gather the various activities of students upon their enrollment at the university, the Atiha System is uses this to provide a holistic assessment of the students in particular and the university in general. The University Information System is an agglomeration of the various sub-systems to process the various information sources of the university. The Atiha Grok System gathers activities happening within the university in various locations such as Auditorium (310), Conference-room (312), Library (314), Study-room (316), Lab (318), Department (320), Faculty-room (322), Classroom (324), Sports-Field (326), and Cafeteria (328). One of the important components of the Atiha Grok System is Any Tablet Phone (ATP) (340). ATP assists in gathering quite a few activities of a student (342) that include interactions with the tablet using a stylus (344) using typically a wireless link (346). The ATP is equipped with a microphone (348), speaker (350), camera (352), RFID tag, RFID reader (354), and Bluetooth connectivity (356). The ATP is in one of the three modes at any point in time: C (Curricular) mode indicates that the activities of a student are curricular activities; similarly, CC (Co-curricular) mode indicates that the activities are co-curricular activities, and finally, EC (Extra-curricular) mode indicates that the activities are extra-curricular in nature. The ATP along with support sub-systems forms the ATP System (360).

FIG. 3A provides a list of typical active components of the Atiha Grok System (370) that includes Any Tablet Phone (ATP) with its accessories, Radio Frequency Identifier (RFID) reader, Camera (roof-mounted), Special Bands (wearable devices), and RFID tags.

FIG. 3B provides a list of support information systems (375): (a) University Voice Sub-System (uVS); (b) University Email Sub-System (uES); (c) University Messaging Sub-System (uMS); (d) University Chat Sub-System (uCS); (e) University Blog Sub-System (uBS); (f) University Collaboration Sub-System (uGS); (g) University Department Sub-System (uDS); (h) University Library Sub-System (uLS); (i) University Lab Sub-System (uRS); (j) University Sports Sub-System (uSS); (k) University Cultural Sub-System (uAS); and (l) University Social Sub-System (uPS).

FIG. 3C provides a list of typical student locations (380): (a) Auditorium; (b) Cafeteria; (c) Classroom; (d) Conference-room; (e) Department; (f) Faculty-room; (g) Lab; (h) Library; (i) Social-activity-location; (j) Sports-field; and (k) Study-room.

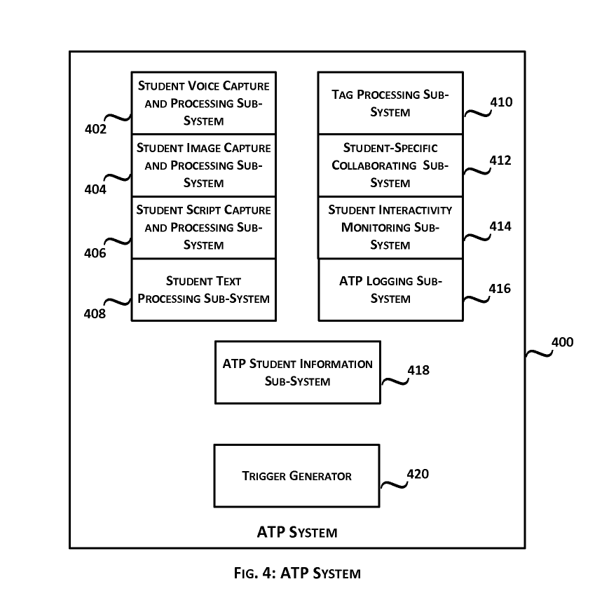

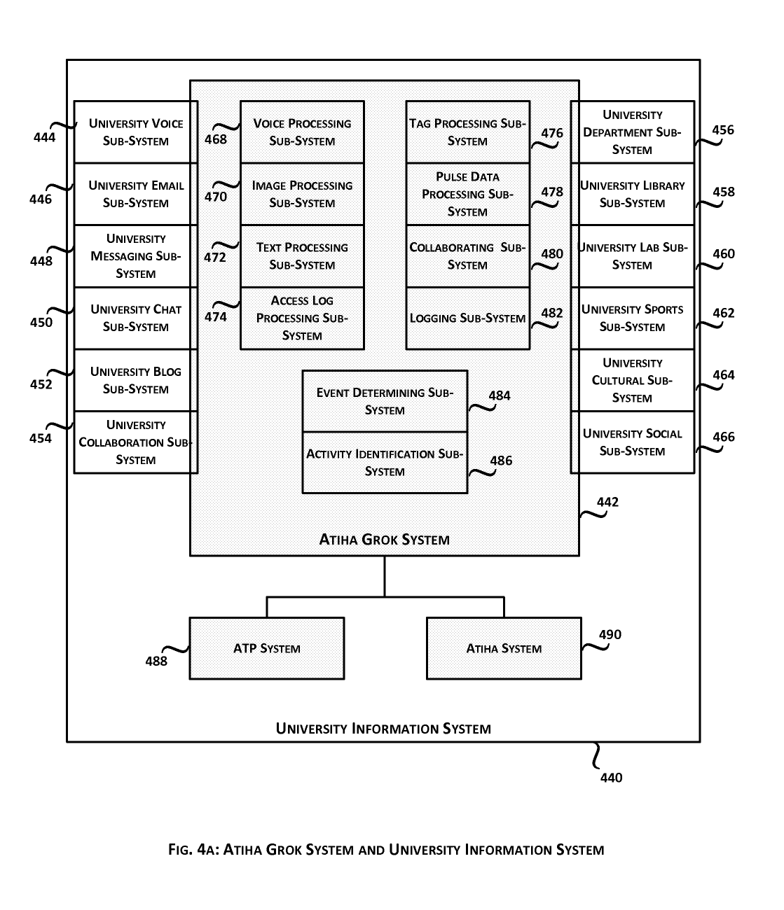

FIG. 4 provides an overview of Any Tablet Phone (ATP) System. The ATP System (400) is a part of the Atiha Grok System and is realized on a tablet in order for the same to be personalized with respect to any particular student. Specifically, each student of a university being assessed for holistic Atiha assessment is provided with an ATP and is typically personalized with respect to that student: there are various forms of personalization including student specific training for speech/voice activity detection, training for facial expression and gestures, and training for handwritten character recognition.

Student Voice Capture and Processing Sub-system (402) is a personalized voice/speech processing subsystem that captures and detects voice activity; On detecting voice activity, the sub-system generates a trigger <ATP, V, TV01>/<ATP, V, TV02> and sends the same to the ATP Grok System. Here, TV01 is trigger related to SELF while TV02 is related to the voice activity due to others. On capturing of voice data, the sub-system preprocesses and analyzes the voice data to extract keywords and sends a trigger <ATP, V, TV03>. The Sub-system analyzes the emotions in the captured voice data to generate a trigger <ATP, V, TV04> with emotion indicators. Similarly, the made/received voice calls are analyzed to generate the triggers: <ATP, P, TV01> and <ATP, P, TV02>.

Student Image Capture and Processing Sub-System (404) analyzes the image of the student captured by the ATP camera and generates appropriate triggers. In particular, the trigger <ATP, I, TV01> is related to raw face image data while the trigger <ATP, I, TV02> is related to the identified facial expressions denoted by gesture indicators.

Student Script Capture and Processing Sub-System (406) analyzes the handwritten text of the student and generates appropriate triggers. The trigger <ATP, W, TV01> is related to the document image data containing the written information while the trigger <ATP, W, TV02> is related to the written textual data including emotion indicators based on the script analysis.

Student Text Processing Sub-System (408) analyzes the text containing in the emails (sent/received), short text messages (sent/received), and chats, and generates the triggers <ATP, M, TV01> and <ATP, M, TV02>.

Tag Processing Sub-System (410) analyzes the tag information such as RFID and Barcode associated with the objects in the vicinity of the ATP and generates appropriate trigger <ATP, F, TV01>.

Student-Specific Collaborating Sub-System (412) is responsible for sending the information related to a student collaborating with others to the Atiha Grok System by generating the trigger <ATP, D, TV01>.

Student Interactivity Monitoring Sub-System (414) monitors the activities of a student using the tablet and generates the appropriate triggers. Illustrative monitored activities include (a) Internet/intranet browsing—trigger: <ATP, B, TV01>; (b) reading of an ebook—trigger: <ATP, R, TV01>; (c) writing onto a document—trigger: <ATP, W, TV01>; (d) chatting and messaging—trigger: <ATP, M, TV01>; (e) blogging—trigger: <ATP, G, TV01>; (f) updating calendar/meeting information—trigger: <ATP, C, TV01>; and (g) other interactions—trigger: <ATP, X, TV01>.

ATP Logging Sub-System (416) generates a log of certain kinds of information and generates an appropriate trigger: <ATP, L, TV01>.

ATP Student Information Sub-System (418) to help support managing of student specific information such as calendars and meeting schedules.

Trigger Generator (420) generates the various triggers and sends the same to the Atiha Grok System for further processing.

FIG. 4A depicts an overview of Atiha Grok System and University Information System.

The University Information System (440) is an agglomeration of a multitude of information sub-systems including Atiha Grok System (442). Specifically, the following information sub-systems (also called as support information systems) are important from Atiha Grok System point of view:

(a) University Voice Sub-System (444) to support intra-university voice calls;

(b) University Email Sub-System (446) to support intra-university emails;

(c) University Messaging Sub-System (448) to support intra-university messaging;

(d) University Chat Sub-System (450) to support intra-university chatting;

(e) University Blog Sub-System (452) to support blogging;

(f) University Collaboration Sub-System (454) to support intra-university collaborations;

(g) University Department Sub-System (456) is a department-level information system;

(h) University Library Sub-System (458) is a library-specific information system;

(i) University Lab Sub-System (460) is a lab-specific information system;

(j) University Sports Sub-System (462) is an information system specific to sports activities of the university;

(k) University Cultural Sub-System (464) is an information system specific to cultural activities of the university; and

(l) University Social Sub-System (466) is an information system specific to social activities of the university.

Atiha Grok System interacts with many of the sub-systems of the University Information System and the major interactions are as follows:

(a) Voice Processing Sub-System (468) interacts with University Voice Sub-System (444);

(b) Image Processing Sub-System (470) interacts with sub-systems such as University Department Sub-System (456), University Library Sub-System (458), and University Lab Sub-System (460). This sub-system receives triggers such as <CAM, I, TV01>.

(c) Text Processing Sub-System (472) interacts with sub-systems such as University Email Sub-System (446), University Messaging Sub-System (448), University Chat Sub-System (450), and University Blog Sub-System (452).

(d) Access Log Processing Sub-System (474) interacts with sub-systems such as University Department Sub-System (456), University Library Sub-System (458), University Lab Sub-System (460), and University Sports Sub-System (462). This sub-system receives triggers such as <ACC, S, TV01>.

(e) Tag Processing Sub-System (476) interacts with sub-systems such as University Library Sub-System (458) and University Lab Sub-System (460). This sub-system receives triggers such as <RFR, F, TV01>.

(f) Pulse Data Processing Sub-System (478) interacts with sub-systems such as University Sports Sub-System (462). This sub-system receives the triggers such as <SPB, P, TV01>.

(g) Collaborating Sub-System (480) interacts with sub-systems such as University Collaboration Sub-System (454).

(h) Logging Sub-System (482) interacts with almost all of the sub-systems of the University Information System and receives triggers such as <XIS, L, TV01>, <XIS, L, TV02>, <XIS, L, TV03>, <XIS, L, TV04>, <XIS, L, TV05>, <XIS, L, TV06>, and <XIS, L,TV07>.

An important sub-system of Atiha Grok System is Event Determining Sub-System (484). This sub-system receives the triggers from the various on-campus devices and the ATP System (488). These received triggers are processed to generate events: while some of the triggers are processed within the ATP System before sending to the server (Atiha Grok System), the other triggers processed within the server using the sub-systems such as Voice Processing Sub-System and Image Processing Sub-System. Activity Identification Sub-System (486) identifies the university-related activities performed by the Students based on the generated events. Finally, the Atiha System (490) uses these identified activities in the holistic assessment of the students.

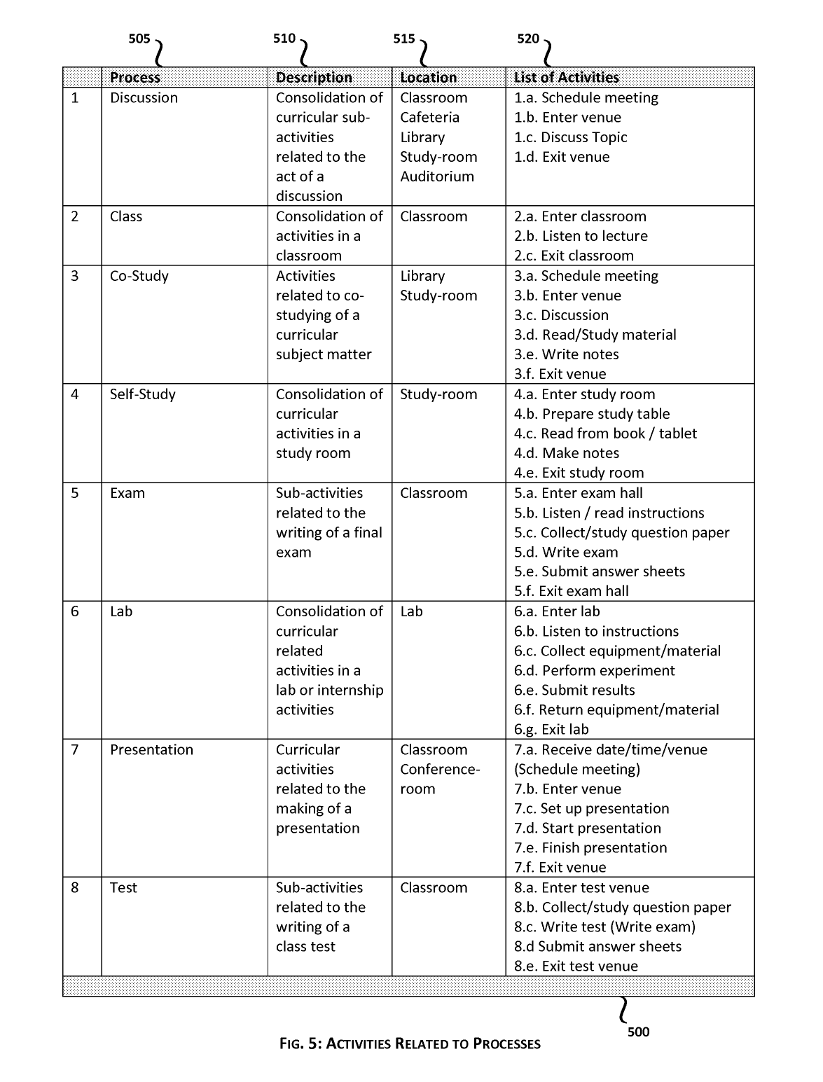

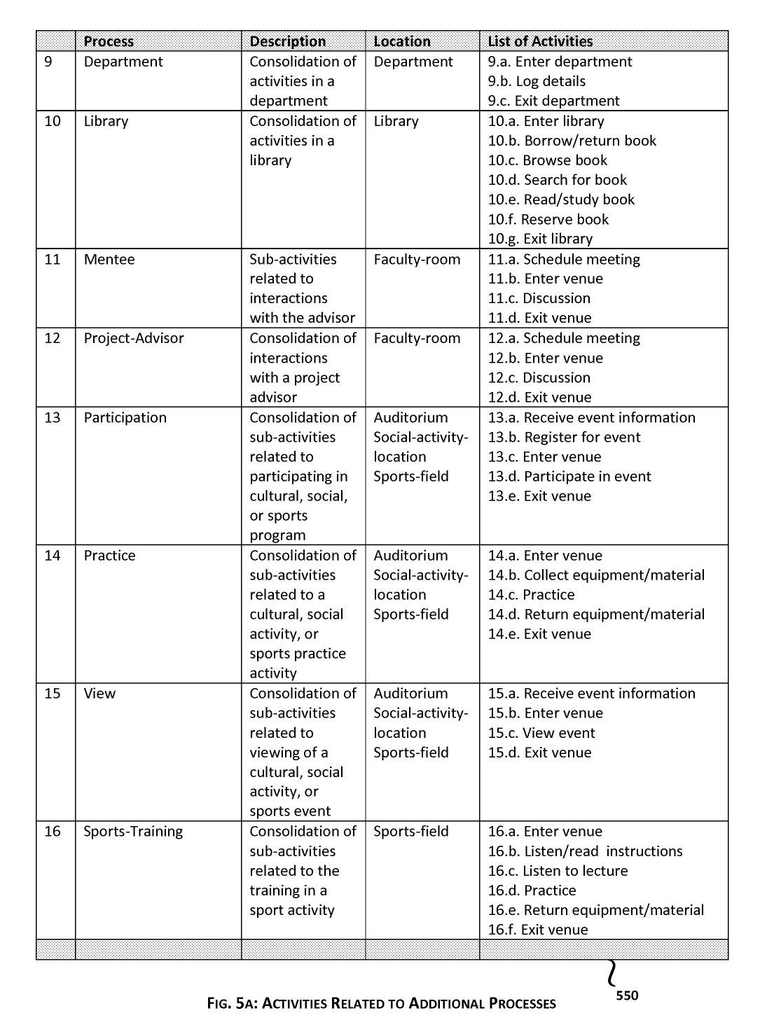

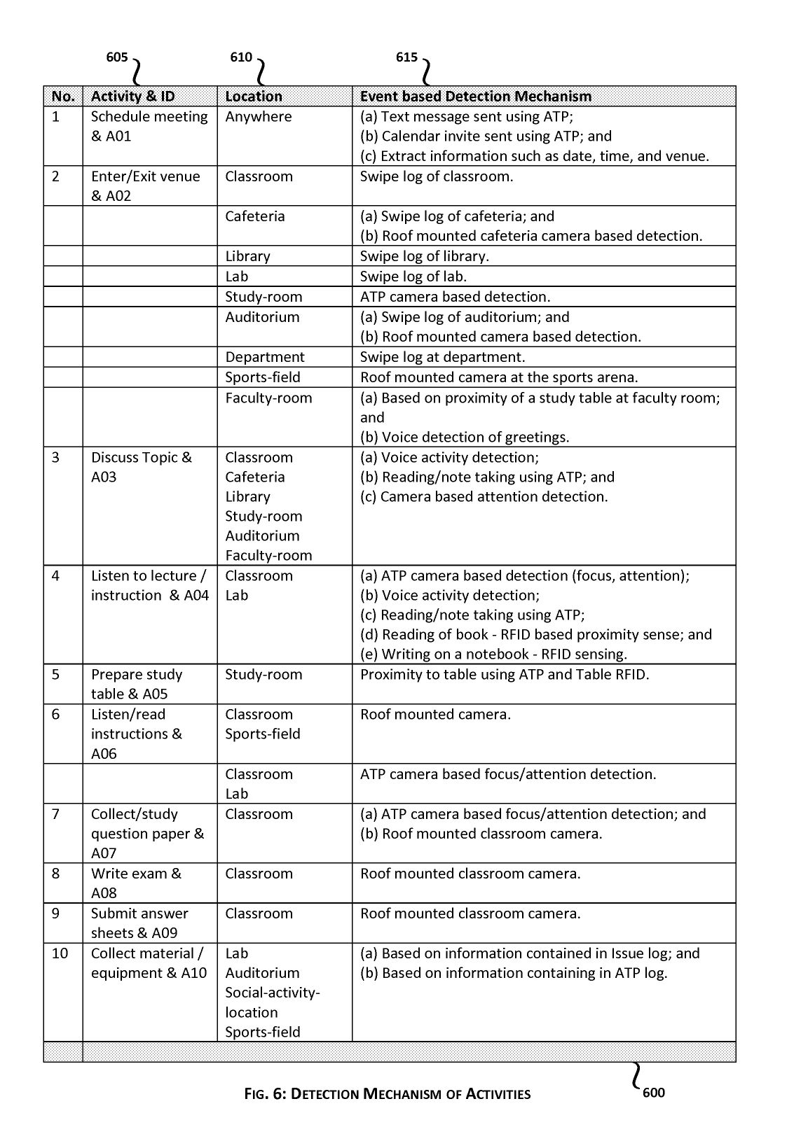

FIG. 5 provides a list of activities related to student processes. A process denotes a certain portions of the activities and interactions of a student either explicitly or implicitly (500). Each process (505) such as “Discussion” and “Class” has an associated description (510) such as “Consolidation of curricular sub-activities related to the act of a discussion” and “Consolidation of activities in a classroom.” In a particular embodiment, each process is of interest and relevance to Atiha Grok System if it happens in a selected list of locations (515). For example, the selected list of locations for “Discussion” is “Classroom,” “Cafeteria,” “Library,” “Study-room,” and “Auditorium.” As mentioned previously, each process is also associated with a certain portion of the activities of a student (520). For example, a list of activities associated with “Discussion” includes “Schedule meeting,” “Enter venue,” “Discuss Topic,” and “Exit venue.” The processes, and the associated locations and activities are arrived at based on the deep domain analysis. The activities associated with some processes are given below.

1. Discussion: Consolidation of curricular sub-activities related to the act of a discussion; The specifications locations of interest include Classroom, Cafeteria, Library, Study-room, and

Auditorium, and the activities include (a) Schedule meeting, (b) Enter venue, (c) Discuss Topic, and (d) Exit venue.

2. Class: Consolidation of activities in a classroom; The specific locations of interest include Classroom the activities include (a) Enter classroom, (b) Listen to lecture, and (c) Exit classroom.

3. Co-Study: Activities related to co-studying of a curricular subject matter; The specific locations include Library and Study-room, and the activities include (a) Schedule meeting, (b) Enter venue, (c) Discussion, (d) Read/Study material, (e) Write notes, and (f) Exit venue.

4. Self-Study: Consolidation of curricular activities in a study room; The specific locations of interest include Study-room and the activities include (a) Enter study room, (b) Prepare study table, (c) Read from book/tablet, (d) Make notes, and (e) Exit study room.

5. Exam: Sub-activities related to the writing of a final exam; The specifications locations of interest include Classroom and the activities include (a) Enter exam hall, (b) Listen/read instructions, (c) Collect/study question paper, (d) Write exam, (e) Submit answer sheets, and (f) Exit exam hall.

6. Lab: Consolidation of curricular related activities in a lab or internship activities; The specifications locations of interest include Lab and the activities include (a) Enter lab, (b) Listen to instructions, (c)

Collect equipment/material, (d) Perform experiment, (e) Submit results, (f) Return equipment/material, and (g) Exit lab.

7. Presentation: Curricular activities related to the making of a presentation; The specifications locations of interest include Classroom and Conference- room, and the activities include (a) Receive date/time/venue (Schedule meeting), (b) Enter venue, (c) Set up presentation, (d) Start presentation, (e) Finish presentation, and (f) Exit venue.

8. Test: Sub-activities related to the writing of a class test; The specifications locations of interest include Classroom, and the activities include (a) Enter test venue, (b) Collect/study question paper, (c) Write test (Write exam), (d) Submit answer sheets, and (e) Exit test venue.

FIG. 5A provides activities related to additional student processes. The details of the additional processes including the locations of interest and activities are provided (550).

The activities associated with some additional processes are given below.

9. Department: Consolidation of activities in a department; The specifications locations of interest include Department, and the activities include (a) Enter department, (b) Log details, and (c) Exit department.

10. Library: Consolidation of activities in a library; The specifications locations of interest include Library, and the activities include (a) Enter library, (b) Borrow/return book, (c) Browse book, (d) Search for book, (e) Read/study book, (f) Reserve book, and (g) Exit library.

11. Mentee: Sub-activities related to interactions with the advisor; The specifications locations of interest include Faculty-room, and the activities include (a) Schedule meeting, (b) Enter venue, (c) Discussion, and (d) Exit venue.

12. Project-Advisor: Consolidation of interactions with a project advisor; The specifications locations of interest include Faculty-room, and the activities include (a) Schedule meeting, (b) Enter venue, (c)

Discussion, and (d) Exit venue.

13. Participation: Consolidation of sub-activities related to participating in cultural, social, or sports program; The specifications locations of interest include Auditorium, Social-activity-location, and Sports-field, and the activities include (a) Receive event information, (b) Register for event, (c) Enter venue, (d) Participate in event, and (e) Exit venue.

14. Practice: Consolidation of sub-activities related to a cultural, social activity, or sports practice activity; The specifications locations of interest include Auditorium, Social-activity-location, and Sports-field, and the activities include (a) Enter venue, (b) Collect equipment/material, (c) Practice, (d) Return equipment/material, and (e) Exit venue.

15. View: Consolidation of sub-activities related to viewing of a cultural, social activity, or sports event; The specifications locations of interest include Auditorium, Social-activity-location, and Sports-field, and the activities include (a) Receive event information, (b) Enter venue, (c) View event, and (d) Exit venue.

16. Sports-Training: Consolidation of sub-activities related to the training in a sport activity; The specifications locations of interest include Sports-field, and the activities include (a) Enter venue (b) Listen/read instructions, (c) Listen to lecture, (d) Practice, (e) Return equipment/material, and (f) Exit venue.

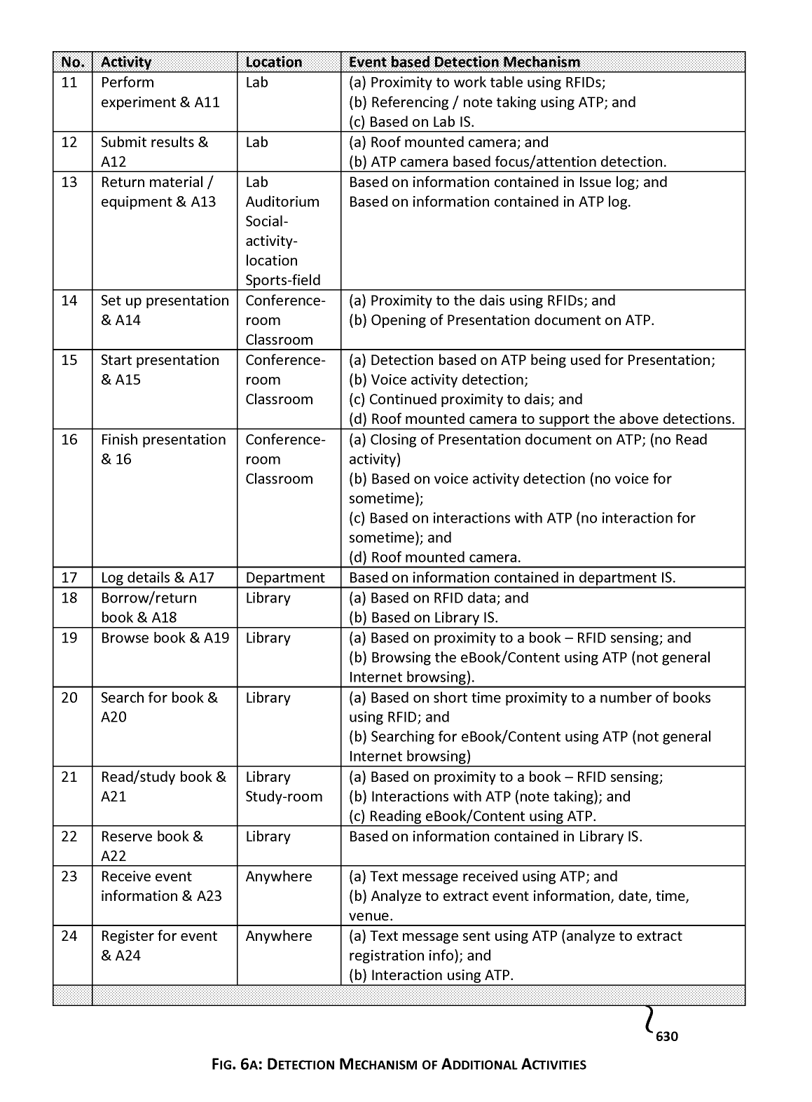

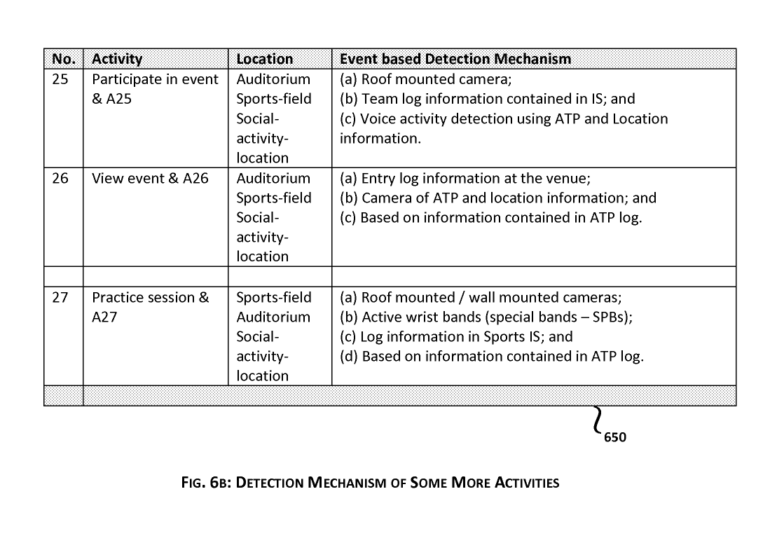

FIG. 6 describes the detection mechanism of activities. The activities of interest are identified based on a set of events (600). Specifically, an event (615) happens at a particular location (610) and provides clues about a particular activity (605) being performed by a student. For example, “Swipe log of classroom” from location “Classroom” provides information about the activity “Enter/Exit venue.”

The detection mechanisms of some of the activities are given below.

1. Schedule meeting & A01: The location could be Anywhere, and the event based detection is at least based on (a) Text message sent using ATP; (b) Calendar invite sent using ATP; and (c) Extract information such as date, time, and venue.

2. Enter/Exit venue & A02: If the location includes Classroom, then the event based detection is at least based on Swipe log of classroom. If the location includes Cafeteria, then the event based detection is at least based on (a) Swipe log of cafeteria; and (b) Roof mounted cafeteria camera based detection. If the location includes Library, then the event based detection is at least based on Swipe log of library. If the location includes Lab, then the event based detection is at least based on Swipe log of lab. If the location includes Study-room, then the event based detection is at least based on ATP camera based detection. If the location includes Auditorium, then the event based detection is at least based on (a) Swipe log of auditorium; and (b) Roof mounted camera based detection. If the location includes Department, then the event based detection is at least based on Swipe log at department. If the location includes Sports-field, then the event based detection is at least based on Roof mounted camera at the sports arena. If the location includes Faculty-room, then the event based detection is at least based on (a) Based on proximity of a study table at faculty room; and (b) Voice detection of greetings.

3. Discuss Topic & A03: If the location includes Classroom, Cafeteria, Library, Study-room, Auditorium, or Faculty-room , then the event based detection is at least based on (a) Voice activity detection; (b) Reading/note taking using ATP; and (c) Camera based attention detection.

4. Listen to lecture/instruction & A04: If the location includes Classroom, or Lab, then the event based detection is at least based on (a) ATP camera based detection (focus, attention); (b) Voice activity detection; (c) Reading/note taking using ATP; (d) Reading of book—RFID based proximity sense; and (e) Writing on a notebook—RFID sensing.

5. Prepare study table & A05: If the location includes Study-room, then the event based detection is at least based on Proximity to table using ATP and Table RFID.

6. Listen/read instructions & A06: If the location includes Classroom, then the event based detection is at least based on Sports-field Roof mounted camera. If the location includes Classroom or Lab, then the event based detection is at least based on ATP camera based focus/attention detection.

7. Collect/study question paper & A07: If the location includes Classroom, then the event based detection is at least based on (a) ATP camera based focus/attention detection; and (b) Roof mounted classroom camera.

8. Write exam & A08: If the location includes Classroom, then the event based detection is at least based on Roof mounted classroom camera.

9. Submit answer sheets & A09: If the location includes Classroom, then the event based detection is at least based on Roof mounted classroom camera.

10. Collect material/equipment & A10: If the location includes Lab, Auditorium, Social-activity-location, or Sports-field, then the event based detection is at least based on (a) Based on information contained in Issue log; and (b) Based on information containing in ATP log.

FIG. 6A describes the detection mechanism of additional activities. The details of the additional activities including the locations of interest and the events are provided (630).

The detection mechanisms of some of the additional activities are given below.

11. Perform experiment & A11: If the location includes Lab, then the event based detection is at least based on (a) Proximity to work table using RFIDs; (b) Referencing/note taking using ATP; and (c) Based on Lab IS.

12. Submit results & A12: If the location includes Lab, then the event based detection is at least based on (a) Roof mounted camera; and (b) ATP camera based focus/attention detection.

13. Return material/equipment & A13: If the location includes Lab, Auditorium, Social-activity-location, or Sports-field, then the event based detection is at least based on (a) Based on information contained in Issue log; and (b)Based on information contained in ATP log.

14. Set up presentation & A14: If the location includes Conference-room, or Classroom, then the event based detection is at least based on (a) Proximity to the dais using RFIDs; and (b) Opening of Presentation document on ATP.

15. Start presentation & A15: If the location includes Conference-room, or Classroom, then the event based detection is at least based on (a) Detection based on ATP being used for Presentation; (b) Voice activity detection; (c) Continued proximity to dais; and (d) Roof mounted camera to support the above detections.

16. Finish presentation & 16: If the location includes Conference-room, or Classroom, then the event based detection is at least based on (a) Closing of Presentation document on ATP; (no Read activity) (b) Based on voice activity detection (no voice for sometime); (c) Based on interactions with ATP (no interaction for sometime); and (d) Roof mounted camera.

17. Log details & A17: If the location includes Department, then the event based detection is at least based on (a) Based on information contained in department IS.

18. Borrow/return book & A18: If the location includes Library, then the event based detection is at least based on (a) Based on RFID data; and (b) Based on Library IS.

19. Browse book & A19: If the location includes Library, then the event based detection is at least based on (a) Based on proximity to a book—RFID sensing; and (b) Browsing the eBook/Content using ATP (not general Internet browsing).

20. Search for book & A20: If the location includes Library, then the event based detection is at least based on (a) Based on short time proximity to a number of books using RFID; and (b) Searching for eBook/Content using ATP (not general Internet browsing).

21. Read/study book & A21: If the location includes Library, or Study-room, then the event based detection is at least based on(a) Based on proximity to a book—RFID sensing; (b) Interactions with ATP (note taking); and (c) Reading eBook/Content using ATP.

22. Reserve book & A22: If the location includes Library, then the event based detection is at least based on (a) Based on information contained in Library IS.

23. Receive event information & A23: If the location is Anywhere, then the event based detection is at least based on (a) Text message received using ATP; and (b) Analyze to extract event information, date, time, venue.

24. Register for event & A24: If the location is Anywhere, then the event based detection is at least based on (a) Text message sent using ATP (analyze to extract registration info); and (b) Interaction using ATP.

FIG. 6B describes the detection mechanism of some more activities. The details of the additional activities including the locations of interest and the events are provided (650).

The detection mechanisms of some of the additional activities are given below.

25. Participate in event & A25: If the location includes Auditorium, Sports-field, or Social-activity-location, then the event based detection is at least based on (a) Roof mounted camera; (b) Team log information contained in IS; and (c) Voice activity detection using ATP and Location information.

26. View event & A26: If the location includes Auditorium, Sports-field, or Social-activity-location, then the event based detection is at least based on (a) Entry log information at the venue; (b) Camera of ATP and location information; and (c) Based on information contained in ATP log.

27. Practice session & A27: If the location includes Sports-field, Auditorium, or Social-activity-location, then the event based detection is at least based on (a) Roof mounted/wall mounted cameras; (b) Active wrist bands (special bands—SPBs); (c) Log information in Sports IS; and (d) Based on information contained in ATP log.

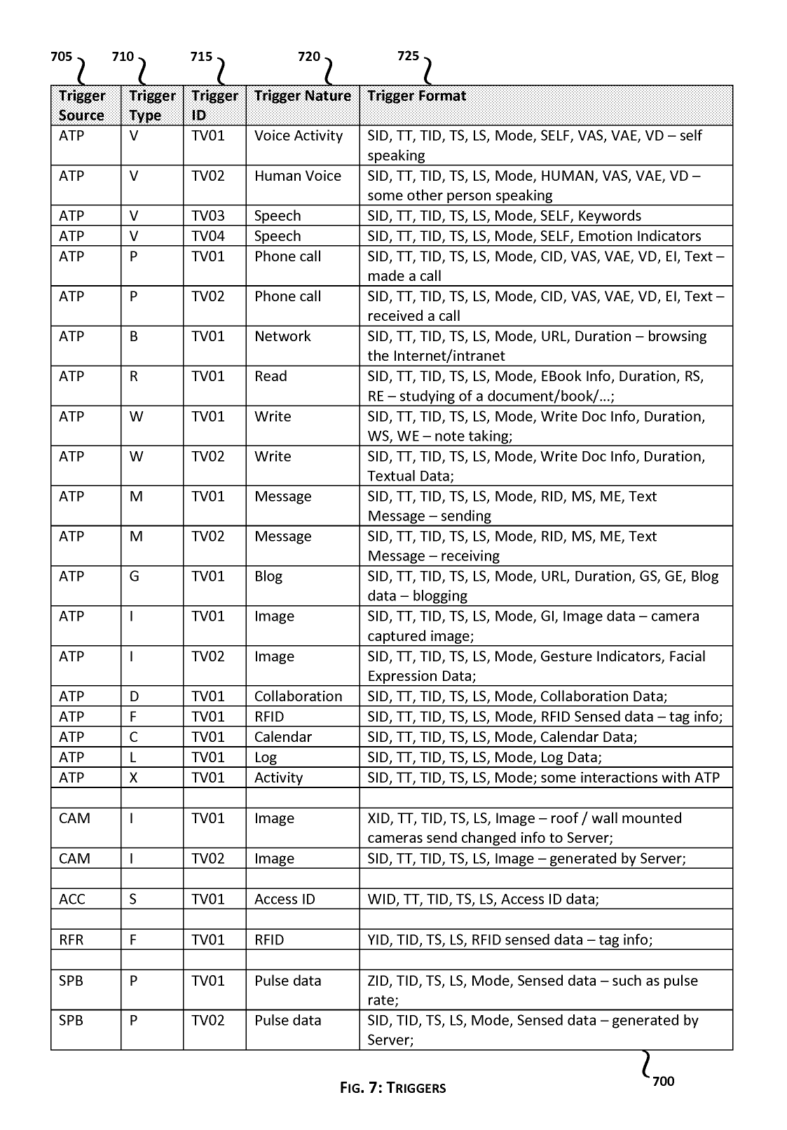

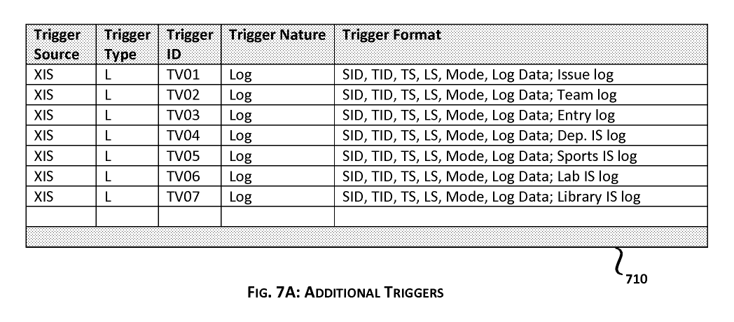

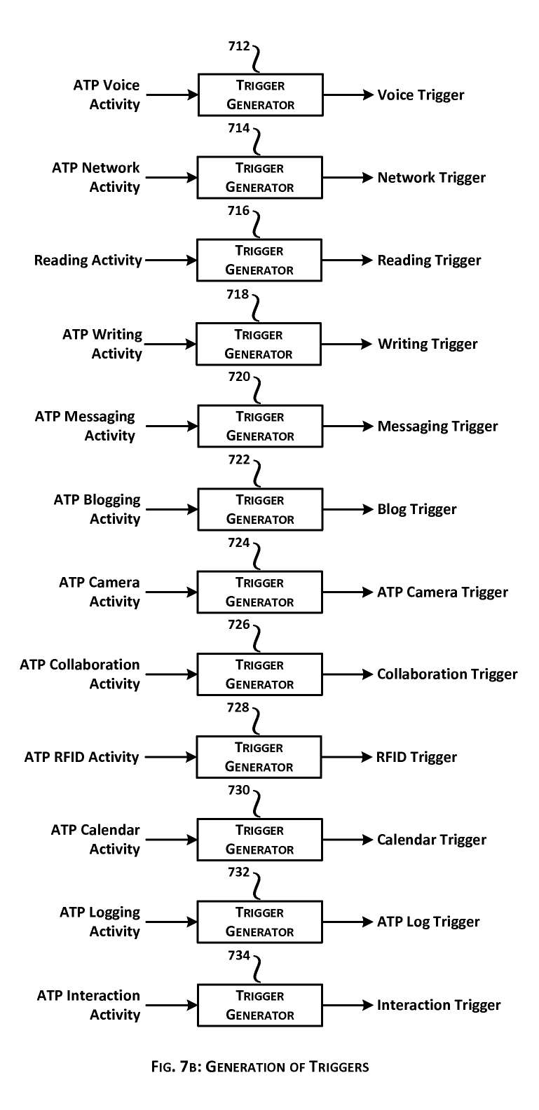

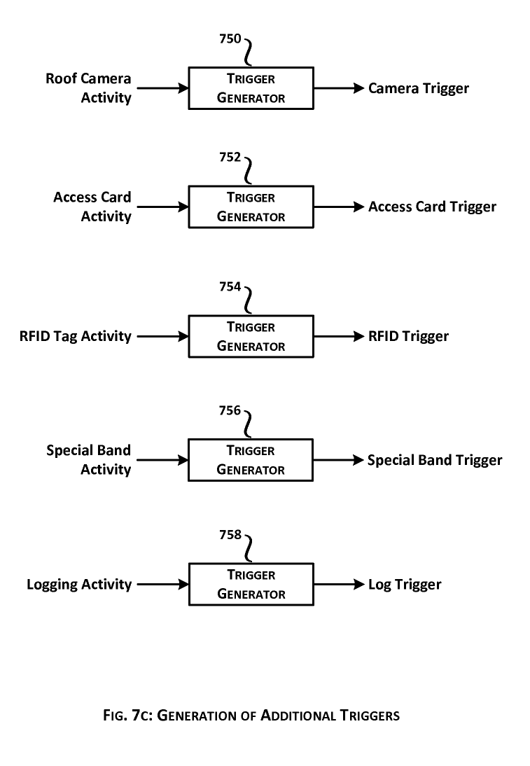

FIG. 7 provides a list of triggers. Triggers form the basis for events and a list of triggers along with relevant details are provided (700). A trigger has a source called trigger source (705). The possible sources include ATP System; CAM—a roof mounted camera in a particular location, say, in a library; ACC—an access system part of a particular location, say a classroom; RFR—Tag information reader such as RFID or barcode reader; SPB—Special bands worn while performing certain kinds of activities; and XLS—a particular logging system.

A trigger type (710) is one of V—voice activity, P—phone activity, B—browsing activity, R—reading activity, W—writing activity, M—messaging activity, G—blogging activity, I—image data, D—collaboration activity, F—tag data, C—calendar data, L—log data, X—interaction with ATP, and P—pulse data.

A trigger ID (715) provides a unique identifier for a trigger.

A trigger nature (720) elaborates on the kind of trigger such as voice activity or phone call.

Finally, a trigger format (725) provides the bulk of the information that gets associated with the generated trigger. Some of the important fields of trigger format are as follows: SID—Student ID; TT—Trigger Type; TID—Trigger ID; CID—Caller ID; RID—Message receiver ID; WID—Access System ID; XID—Camera ID; YID—RFID Reader ID; ZID—Band IDs; TS—Timestamp; VAS—voice activity start; VAE: voice activity end; VD—Voice Data; LS: Location-stamp; RS—Read start; RE—Read end; WS—Write start; WE—Write end; MS—Message start; ME—Message end; GS—Blog start; GE—Blog end; EI—Emotion indicator; Text—textual data; Mode (C (for curricular activity)/CC (co-curricular activity)/EC (extra-curricular activity); and GI—Gesture indicator.

The details of the various triggers are provided below (under the heading Trigger Source, Trigger Type, Trigger ID, Trigger Nature, and Trigger Format).

1. ATP V TV01 Voice Activity SID, TT, TID, TS, LS, Mode, SELF, VAS, VAE, VD—self speaking;

2. ATP V TV02 Human Voice SID, TT, TID, TS, LS, Mode, HUMAN, VAS, VAE, VD—some other person speaking;

3. ATP V TV03 Speech SID, TT, TID, TS, LS, Mode, SELF, Keywords;

4. ATP V TV04 Speech SID, TT, TID, TS, LS, Mode, SELF, Emotion Indicators;

5. ATP P TV01 Phone call SID, TT, TID, TS, LS, Mode, CID, VAS, VAE, VD, EI, Text—made a call;

6. ATP P TV02 Phone call SID, TT, TID, TS, LS, Mode, CID, VAS, VAE, VD, EI, Text—received a call;

7. ATP B TV01 Network SID, TT, TID, TS, LS, Mode, URL, Duration—browsing the Internet/intranet;

8. ATP R TV01 Read SID, TT, TID, TS, LS, Mode, EBook Info, Duration, RS, RE—studying of a document/book/ . . . ;

9. ATP WTV01 Write SID, TT, TID, TS, LS, Mode, Write Doc Info, Duration, WS, WE—note taking;

10. ATP WTV02 Write SID, TT, TID, TS, LS, Mode, Write Doc Info, Duration, Textual Data;

11. ATP M TV01 Message SID, TT, TID, TS, LS, Mode, RID, MS, ME, Text Message—sending;

12. ATP M TV02 Message SID, TT, TID, TS, LS, Mode, RID, MS, ME, Text Message—receiving;

13. ATP G TV01 Blog SID, TT, TID, TS, LS, Mode, URL, Duration, GS, GE, Blog data—blogging;

14. ATP I TV01 Image SID, TT, TID, TS, LS, Mode, GI, Image data—camera captured image;

15. ATP I TV02 Image SID, TT, TID, TS, LS, Mode, Gesture Indicators, Facial Expression Data;

16. ATP D TV01 Collaboration SID, TT, TID, TS, LS, Mode, Collaboration Data;

17. ATP F TV01 RFID SID, TT, TID, TS, LS, Mode, RFID Sensed data—tag info;

18. ATP C TV01 Calendar SID, TT, TID, TS, LS, Mode, Calendar Data;

19. ATP L TV01 Log SID, TT, TID, TS, LS, Mode, Log Data;

20. ATP X TV01 Activity SID, TT, TID, TS, LS, Mode; some interactions with ATP;

21. CAM I TV01 Image XID, TT, TID, TS, LS, Image—roof/wall mounted cameras send changed info to Server;

22. CAM I TV02 Image SID, TT, TID, TS, LS, Image—generated by Server;

23. ACC STV01 Access ID WID, TT, TID, TS, LS, Access ID data;

24. RFR F TV01 RFID YID, TID, TS, LS, RFID sensed data—tag info;

25. SPB P TV01 Pulse data ZID, TID, TS, LS, Mode, Sensed data—such as pulse rate;

26. SPB P TV02 Pulse data SID, TID, TS, LS, Mode, Sensed data—generated by Server;

FIG. 7A provides a list of additional triggers. The information related to additional triggers is provided (710).

The details of some of the additional triggers are provided below (under the heading Trigger Source, Trigger Type, Trigger ID, Trigger Nature, and Trigger Format).

27. XIS L TV01 Log SID, TID, TS, LS, Mode, Log Data; Issue log

28. XIS L TV02 Log SID, TID, TS, LS, Mode, Log Data; Team log

29. XIS L TV03 Log SID, TID, TS, LS, Mode, Log Data; Entry log

30. XIS L TV04 Log SID, TID, TS, LS, Mode, Log Data; Dep. IS log

31. XIS L TV05 Log SID, TID, TS, LS, Mode, Log Data; Sports IS log

32. XIS L TV06 Log SID, TID, TS, LS, Mode, Log Data; Lab IS log

33. XIS L TV07 Log SID, TID, TS, LS, Mode, Log Data; Library IS log

Observe the following:

(a) Network trigger is based on the network related activity such as accessing of the University network or Internet;

(b) Triggers related to Discussion, Collaboration, and Whiteboard are sort of used interchangeably.

(c) Regarding logging: Logs provide useful information about some of the activities of the students.

In particular, note that the following:

(i) Issue log (Item 27) is related to the support information systems such as University Lab Sub-System, University Library Sub-System, University Sports Sub-System, University Cultural Sub-System, University Social Sub-System, and University Department Sub-System;

(ii) Team log (Item 28) is related to the support information systems such as University Lab Sub-System, University Sports Sub-System, University Cultural Sub-System, and University Social Sub-System; and

(iii) Entry log (Item 29) is related to the support information systems such as University Lab Sub-System, University Library Sub-System, University Sports Sub-System, University Cultural Sub-System, University Social Sub-System, and University Department Sub-System.

(d) Textual data is analyzed to determine the emotion indicators. Specifically, textual data is obtained directly from emails, messages, and blogs. Additionally, textual data is also obtained from voice data by performing personalized speech recognition. Further, the usage of the tablet whiteboard during collaboration/discussion provides the handwritten content that is analyzed by a script recognition system based on Optical Character Recognition (OCR) technology to determine the textual content. Some of the literature references include the following.

(i) A paper “A Survey of Affect Recognition Methods: Audio, Visual and Spontaneous Expressions” by Zhihong Zeng, Maja Pantic, Glenn I. Roisman and Thomas S. Huang appeared in the proceedings of the ICMI'07, Nov. 12-15, 2007, Nagoya, Aichi, Japan.

(ii) A paper “Analysis of Emotion Recognition using Facial Expressions, Speech and Multimodal Information” by Carlos Busso, Zhigang Deng, Serdar Yildirim, Murtaza Bulut, Chul Min Lee, Abe Kazemzadeh, Sungbok Lee, Ulrich Neumann, and Shrikanth Narayanan appeared in the proceedings of the ICMI'04, Oct. 13-15, 2004, State College, Pa., USA.

(iii) A paper “Multimodal human-computer interaction: A survey” by Alejandro Jaimes, and Nicu Sebe appeared in Computer Vision and Image Understanding 108 (2007) 116-134.

(iv) A paper “Facial Expression and Gesture Analysis for Emotionally-Rich Man-Machine Interaction” by Kostas Karpouzis, Amaryllis Raouzaiou, Athanasios Drosopoulos, Spiros loannou, Themis Balomenos, Nicolas Tsapatsoulis, and Stefanos Kollias appeared as a chapter in the book Emotionally-Rich Man-Machine Interaction copyrighted by Idea Group Inc., 2004.

(v) A paper “Learning to Identify Emotions in Text” by Carlo Strapparava and Rada Mihalcea appeared in the proceedings of the SAC'08 March 1620, 2008, Fortaleza, Cear'a, Brazil.

(vi) A paper “Multi-Modal Emotion Recognition from Speech and Text” by Ze-Jing Chuang and Chung-Hsien Wu appeared in Computational Linguistics and Chinese Language Processing, Vol. 9, No. 2, August 2004, pp. 45-62.

(vii) A paper “Text Entry Performance of State of the Art Unconstrained Handwriting Recognition: A Longitudinal User Study” by Per Ola Kristensson and Leif C. Denby appeared in the Proceedings of CHI 2009, Apr. 4-9, 2009, Boston, Mass., USA.

(viii) A paper “Speech Recognition by Machine: A Review” by M. A. Anusuya and S. K. Katti appeared in (IJCSIS) International Journal of Computer Science and Information Security, Vol. 6, No. 3, 2009.

(e) Many pattern analysis and recognition techniques are part of the embodiment to realize the presented invention.

(i) The analysis of voice (speech and non-speech), images (faces), and textual data is a well researched area.

(ii) A vast number of techniques are described in the literature to support personalized speech recognition.

(iii) A large array of techniques and solutions are proposed in the literature for image analysis.

(iv) Textual data analysis has also been widely studied both from syntax and semantics point of view.

(v) The OCR field is highly matured providing techniques for both printed and handwritten textual content analysis.

(f) The usage of standard techniques such as above leads to the identification of emotion indicators and gesture indicators. In a particular embodiment, these indicators bring out a positive disposition (+1), neutral (0), or negative disposition (−1).

FIG. 7B provides a description of the generation of triggers.

712 depicts the generation of a voice trigger based on an ATP voice activity.

714 depicts the generation of a network trigger based on an ATP network activity.

716 depicts the generation of a reading trigger based on an ATP reading activity.

718 depicts the generation of a writing trigger based on an ATP writing activity.

720 depicts the generation of a messaging trigger based on an ATP messaging activity.

722 depicts the generation of a blog trigger based on an ATP blogging activity.

724 depicts the generation of an ATP camera trigger based on an ATP camera activity.

726 depicts the generation of a collaboration trigger based on an ATP collaboration activity.

728 depicts the generation of an RFID trigger based on an ATP RFID activity.

730 depicts the generation of a calendar trigger based on an ATP calendar activity.

732 depicts the generation of an ATP log trigger based on an ATP logging activity.

734 depicts the generation of an interaction trigger based on an ATP interaction activity.

FIG. 7C provides a description of the generation of additional triggers.

750 depicts the generation of a camera trigger based on a roof camera activity.

752 depicts the generation of an access card trigger based on an access card activity.

754 depicts the generation of an RFID trigger based on an RFID tag activity.

756 depicts the generation of a special band trigger based on a special band activity.

758 depicts the generation of a log trigger based on a logging activity.

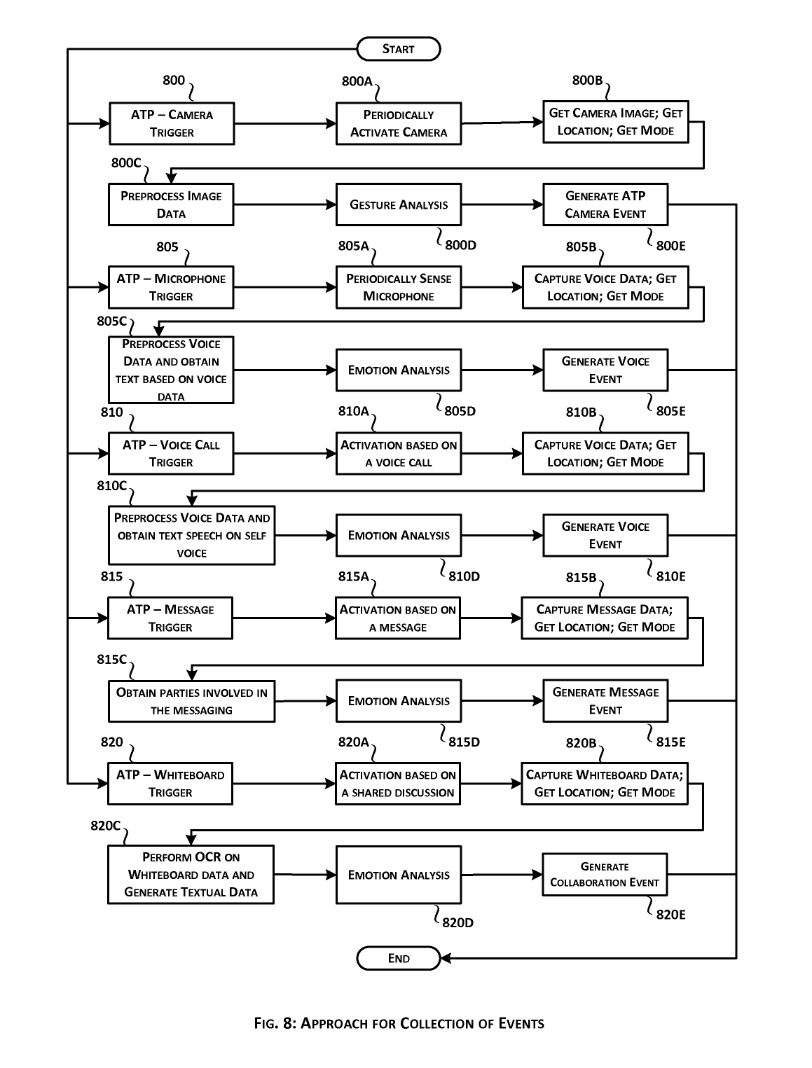

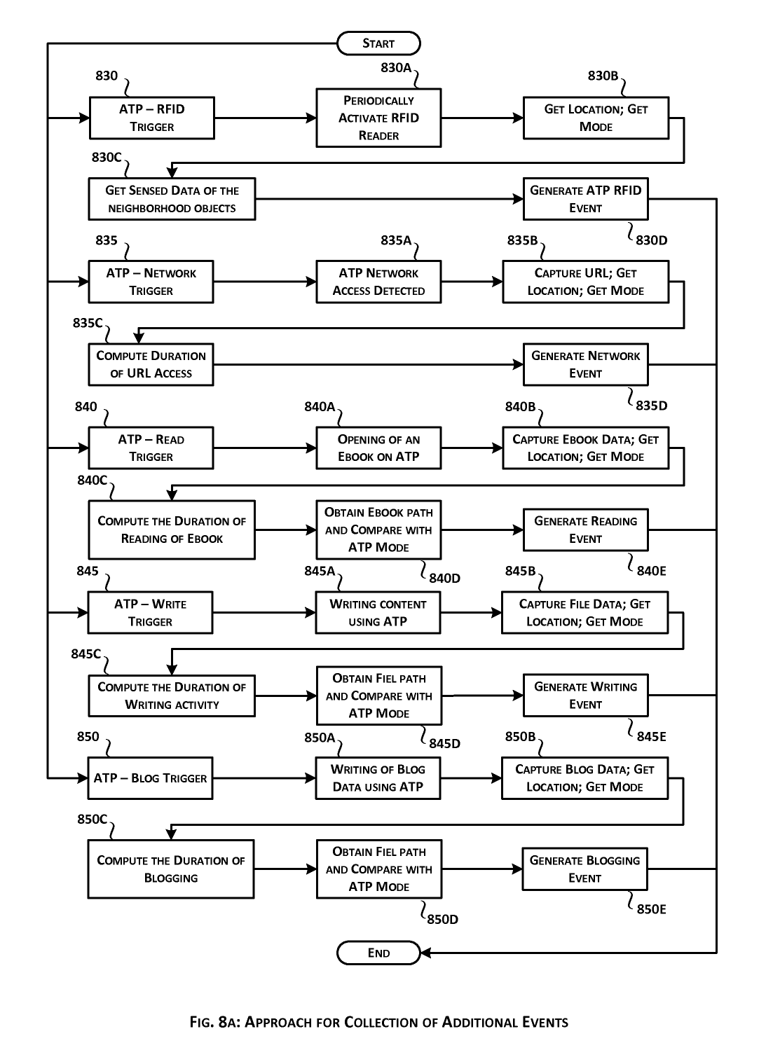

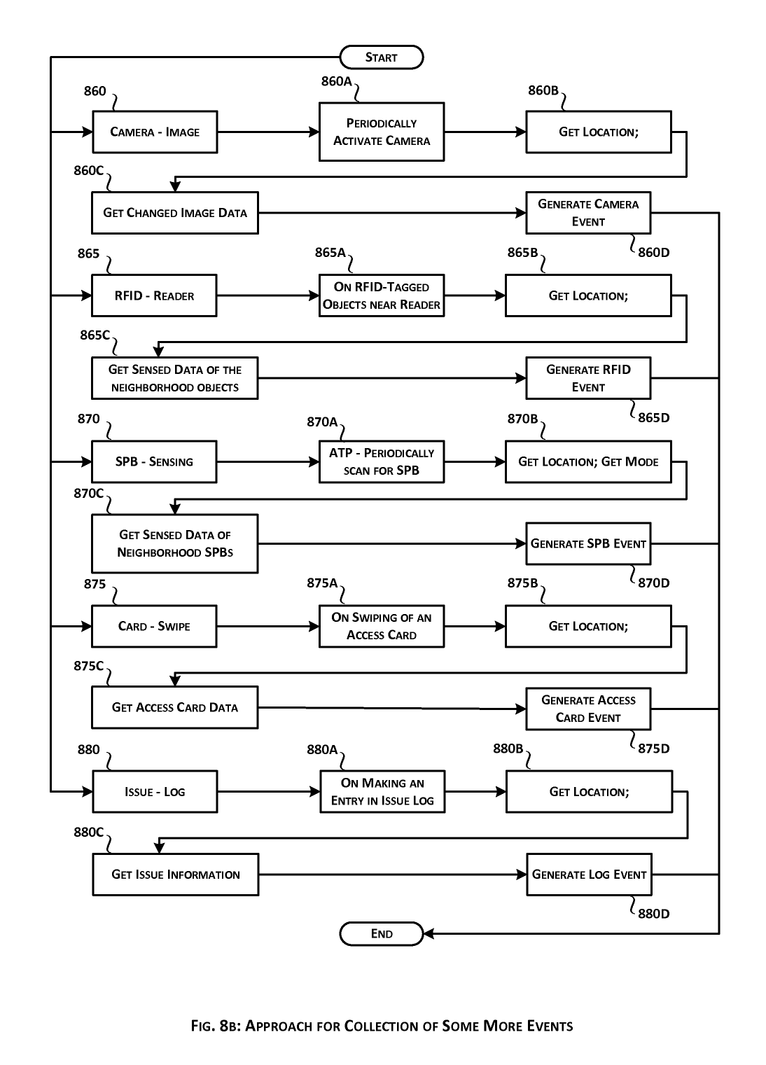

FIG. 8 provides an approach for collection of events. The collected events are based on triggers that originate from multiple sources. ATP-Camera trigger (800) is based on the image captured by the camera attached to an ATP system. In a particular embodiment, the camera is activated periodically (800A) and the image is captured (800B). The current location of ATP if available and the ATP mode is obtained. The captured image is preprocessed (800C). The preprocessing is student-specific in the sense there is a training procedure involving the various facial expressions. Based on the obtained image data and the trained set of student-specific facial models, gesture analysis is performed to result in Gesture Indicators (800D). Finally, the trigger along with the associated information is sent to Atiha Grok System to generate ATP Camera Event (800E).

ATP-Microphone trigger (805) is based on the detected voice activity. In a particular embodiment, the microphone of the ATP System is periodically sensed (805A). If there is a voice activity, the voice data is captured (805B). The current location of ATP if available and the ATP mode is obtained. The captured voice data is preprocessed (805C). The preprocessing is student-specific in the sense that there is a training procedure involving various emotional expressions and key phrases. Based on the obtained voice data and the trained set of student-specific voice models, emotional analysis is performed (805D) to result in Emotion Indicators. Finally, the trigger along with the associated information is sent to Atiha Grok System to generate Voice Event (805E).

ATP-Voice Call trigger (810) is based on the detected voice activity. In a particular embodiment, the microphone of the ATP System is periodically sensed and if there is a voice activity (805A), the voice data is captured while making or receiving of a voice call (810B). The current location of ATP if available and the ATP mode is obtained. The involved parties in the voice call are determined. The captured voice data is preprocessed (810C) based on the trained set of student-specific voice models to identify textual data. Emotional analysis is performed to result in Emotion Indicators (810D). Finally, the trigger along with the associated information is sent to Atiha Grok System to generate Voice Event (810E).

ATP-Message trigger (815) is based on the detected messaging related activity. In a particular embodiment, the ATP System is periodically monitored and if there is a messaging activity (815A), the message data is captured (815B). The current location of ATP if available and the ATP mode is obtained. The involved parties in the messaging are determined (815C). Emotional analysis is performed to result in Emotion Indicators (815D). Finally, the trigger along with the associated information is sent to Atiha Grok System to generate Message Event (815E).

ATP-Whiteboard trigger (also called as ATP-Discussion trigger) (820) is based on the detected collaborative discussion activity. In a particular embodiment, the ATP System is periodically monitored and if there is a shared whiteboard based discussion (820A), the whiteboard data is captured (820B). The current location of ATP if available and the ATP mode is obtained. Optical

Character Recognition (OCR) is performed based on the whiteboard data using the student-specific script models and textual data is generated (820C). The student-specific script models are determined based on a student-specific training data. The textual data is analyzed to determine Emotion Indicators (820D). Finally, the trigger along with the associated information is sent to Atiha Grok System to generate Collaboration Event (820E).

FIG. 8A provides an approach for collection of additional events.

ATP-RFID trigger (830) is based on the detected RFID tag information in the neighborhood. In a particular embodiment, the RFID reader of the ATP System is periodically activated (830A) and if there are objects in the neighborhood with RFID tags, the tag information is captured (830C). The current location of ATP if available and the ATP mode is obtained (830B). Finally, the trigger along with the associated information is sent to Atiha Grok System to generate ATP RFID Event (830D). ATM-Network trigger (835) is based on the detected network activity. In a particular embodiment, on detection of network activity of the ATP System (835A), capture the universal resource location (URL) and related information (835B). The current location of ATP if available and the ATP mode is obtained. Compute the duration of access (835C). Finally, the trigger along with the associated information is sent to Atiha Grok System to generate Network Event (835D).

ATM-Read trigger (840) is based on the detected reading activity. In a particular embodiment, on detection of opening of an ebook on ATP System (840A), capture the ebook related information (840B). The current location of ATP if available and the ATP mode is obtained. Compute the duration of reading activity (840C). Obtain the ebook path and compare the same with the ATP mode (840D). In a particular embodiment, the file system of ATP is organized in a distinct manner with respect to the ATP mode. For example, there is a separate directory called “curricular” and all the information related to curricular activities (that is, ATP mode being C mode), are relative to this directory. In other words, the path of ebook being read while ATP is in C mode must be relative the directory “curricular.” Similarly, there are directories called “co-curricular” and “extra-curricular” for storing the information related to co-curricular and extra-curricular activities respectively. Finally, the trigger along with the associated information is sent to Atiha Grok System to generate Reading Event (840E).

ATM-Write trigger (845) is based on the detected writing activity. In a particular embodiment, on detection of writing using the ATP System (845A), capture the file related information (845B). The current location of ATP if available and the ATP mode is obtained. Compute the duration of writing activity (845C). Obtain the file path and compare the same with the ATP mode (845D). Finally, the trigger along with the associated information is sent to Atiha Grok System to generate Writing Event (845E).

ATM-Blog trigger (850) is based on the detected blogging activity. In a particular embodiment, on detection of blogging using the ATP System (850A), capture the blog related information (850B). The current location of ATP if available and the ATP mode is obtained. Compute the duration of blogging activity (850C). Obtain the file path and compare the same with the ATP mode (850D). Finally, the trigger along with the associated information is sent to Atiha Grok System to generate Blogging Event (850E).

FIG. 8B provides an approach for collection of some more events. Camera-Image trigger (860) is based on the image captured by a roof mounted camera in various locations. In a particular embodiment, the camera is periodically activated (860A). The current location of the camera is obtained (860B). The changed camera image is obtained (860C). Finally, the trigger along with the associated information is sent to Atiha Grok System to generate Camera Event (860D).

RFID-Reader trigger (865) is based on the signal received from the RFID tagged objects by an RFID reader. On determining the RFID tagged objected in the neighborhood (865A), get the sensed data of the neighborhood objects (865C). The current location of the RFID reader is obtained (865B). Finally, the trigger along with the associated information is sent to Atiha Grok System to generate RFID Event (865D).

SPB-Sensing trigger (870) is based on the signal received from the special bands. In a particular embodiment, the system periodically scans for SPBs (870A), get the sensed data of the neighborhood SPBs (870C). The current location of ATP if available and the ATP mode is obtained (870B). Finally, the trigger along with the associated information is sent to Atiha Grok System to generate SPB Event (870D).

Card-Swipe trigger (875) is based on access card being swiped. On swiping of an access card (875A) with respect to an access card reader, get the access card data (875C). The current location of the access card reader is obtained (875B). Finally, the trigger along with the associated information is sent to Atiha Grok System to generate Access Card Event (875D).

Issue-Log trigger (880) is based on making of an entry in an issue log. A particular embodiment considers various types of issue logs: Issue log—information logged in say University Lab Sub-System, University Library Sub-System, University Sports Sub-System, or University Cultural Sub-System. A general Log trigger is based on information logged in various information systems such as ATP log—information logged by the ATP Logging Sub-System; Team log—information logged about the various teams as per University Department Sub-System, University Sports Sub-System, or University

Cultural Sub-System; Entry log—entry/exit information as per University Department Sub-System, University Library Sub-System, University Lab-Sub-System, University Sports Sub-System, University Cultural Sub-System, or University Social Sub-System. The current location of the point of data logging if available is obtained (880B). Get logged information (880C). Finally, the trigger along with the associated information is sent to Atiha Grok System to generate Log Event (880D).

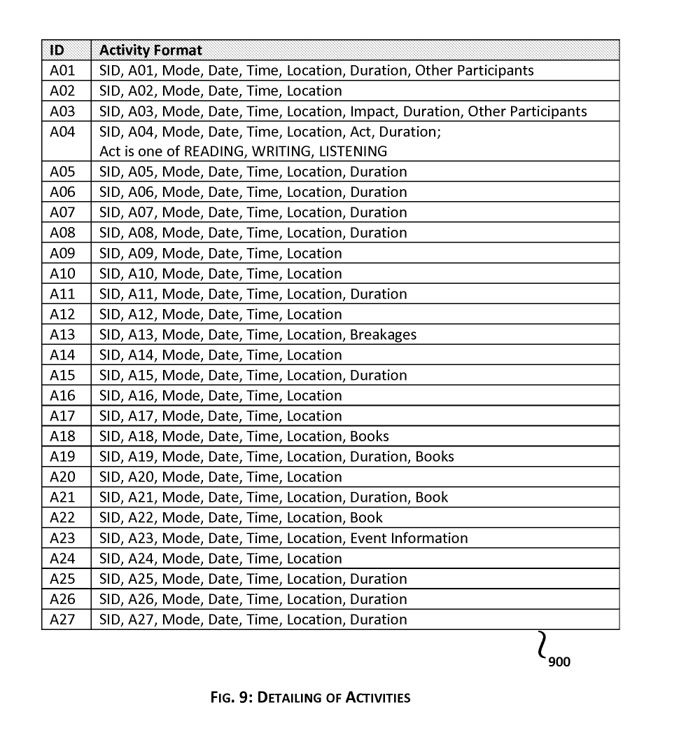

FIG. 9 depicts detailing of activities. A particular embodiment identifies a certain number of activities and associates the same with a set of information (900). For example, A01 is related to the activity of scheduling a meeting and the associated information includes Student who is convening the meeting, date, time, and location of the meeting, and the other participants of the meeting. Note that the information related to an activity also includes emotion and gesture indicators if any that are associated with the corresponding events.

The information associated with the various activities is provided below.

1. A01: SID, A01, Mode, Date, Time, Location, Duration, Other Participants;

2. A02: SID, A02, Mode, Date, Time, Location;

3. A03: SID, A03, Mode, Date, Time, Location, Impact, Duration, Other Participants;

4. A04: SID, A04, Mode, Date, Time, Location, Act, Duration; Act is one of READING, WRITING, LISTENING;

5. A05: SID, A05, Mode, Date, Time, Location, Duration;

6. A06: SID, A06, Mode, Date, Time, Location, Duration;

7. A07: SID, A07, Mode, Date, Time, Location, Duration;

8. A08: SID, A08, Mode, Date, Time, Location, Duration;

9. A09: SID, A09, Mode, Date, Time, Location;

10. A10: SID, A10, Mode, Date, Time, Location;

11. A11: SID, A11, Mode, Date, Time, Location, Duration;

12. A12: SID, A12, Mode, Date, Time, Location;

13. A13: SID, A13, Mode, Date, Time, Location, Breakages;

14. A14: SID, A14, Mode, Date, Time, Location;

15. A15: SID, A15, Mode, Date, Time, Location, Duration;

16. A16: SID, A16, Mode, Date, Time, Location;

17. A17: SID, A17, Mode, Date, Time, Location;

18. A18: SID, A18, Mode, Date, Time, Location, Books;

19. A19: SID, A19, Mode, Date, Time, Location, Duration, Books;

20. A20: SID, A20, Mode, Date, Time, Location;

21. A21: SID, A21, Mode, Date, Time, Location, Duration, Book;

22. A22: SID, A22, Mode, Date, Time, Location, Book;

23. A23: SID, A23, Mode, Date, Time, Location, Event Information;

24. A24: SID, A24, Mode, Date, Time, Location;

25. A25: SID, A25, Mode, Date, Time, Location, Duration;

26. A26: SID, A26, Mode, Date, Time, Location, Duration;

27. A27: SID, A27, Mode, Date, Time, Location, Duration;

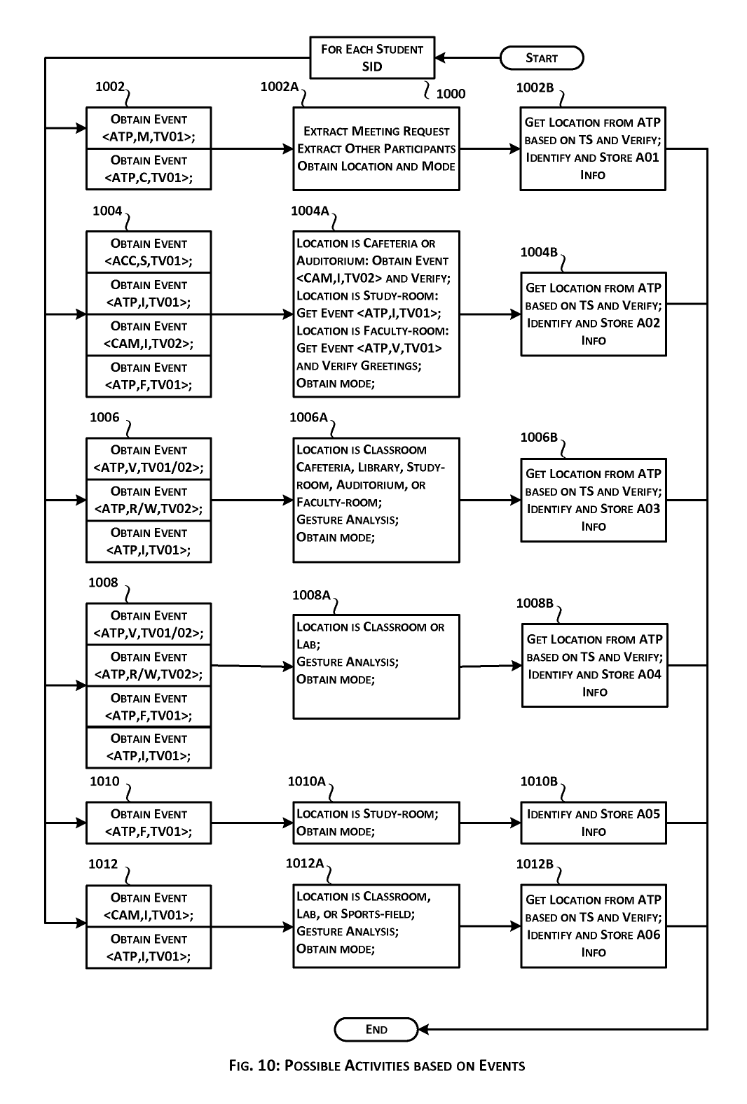

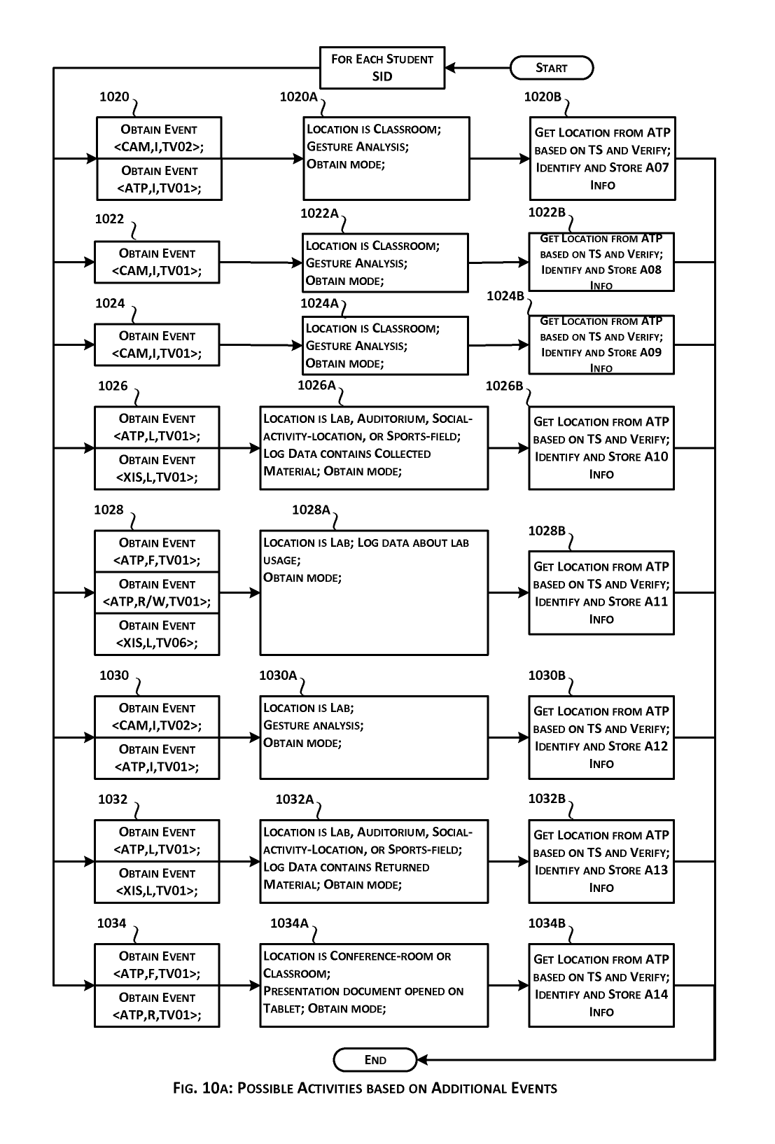

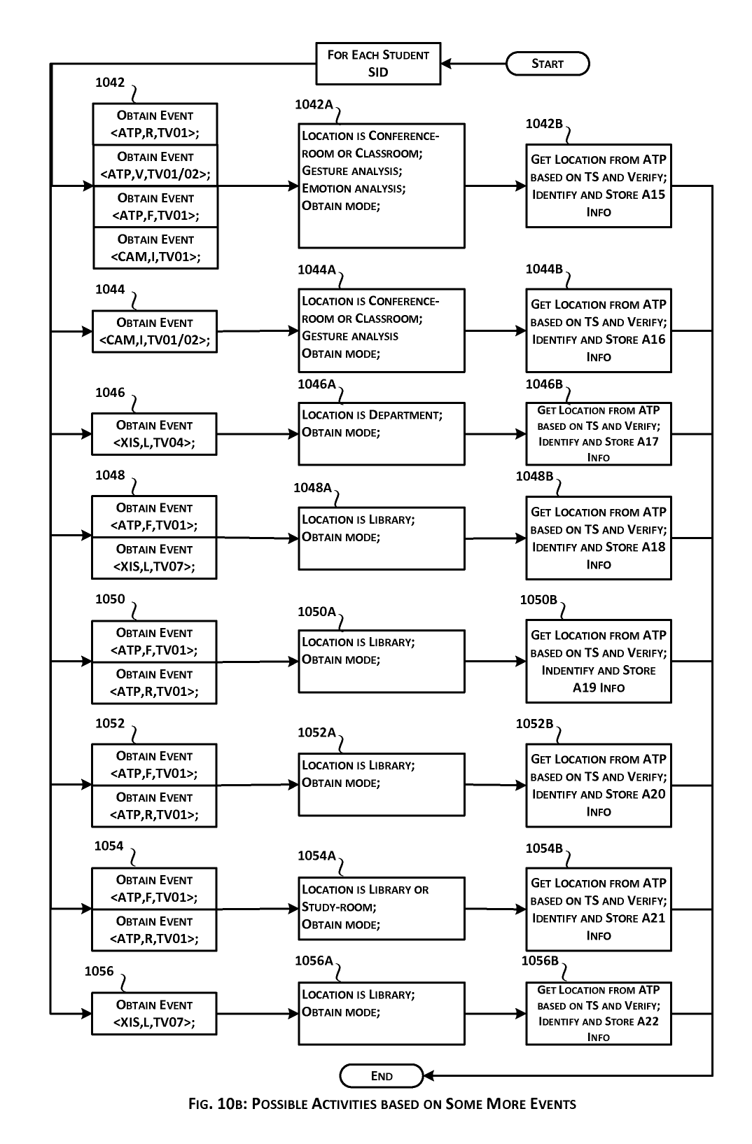

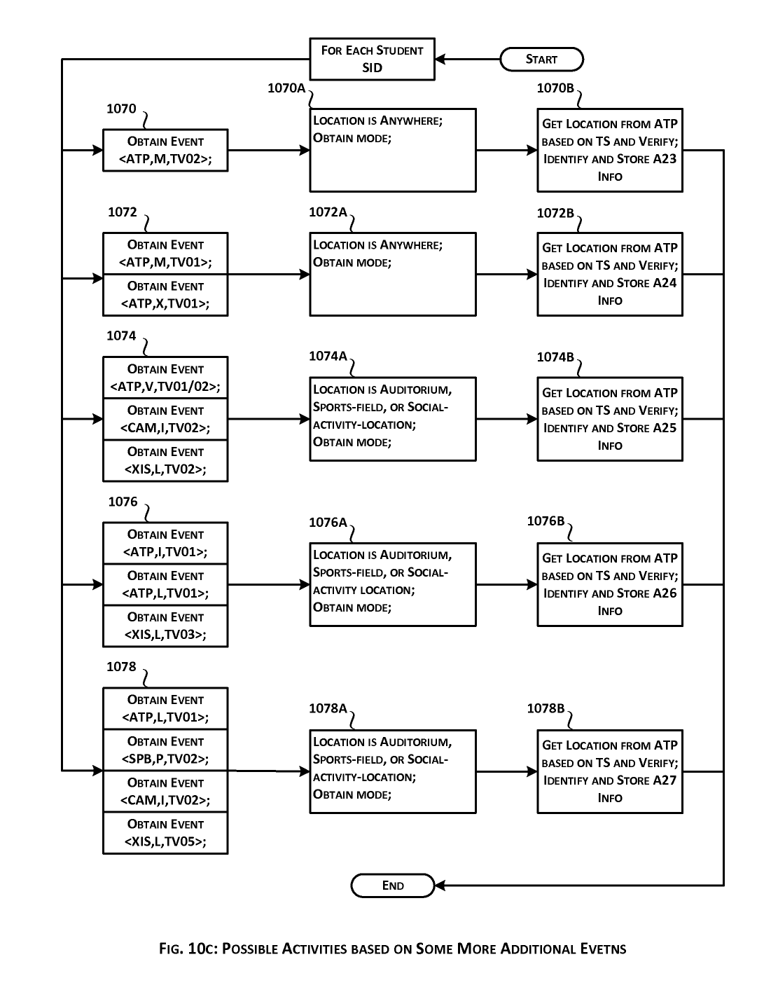

FIG. 10 provides the detection of possible activities based on events. Activity detection is based on the events that are in turn based on the generated triggers.

The main steps are as follows.

Step 1: Triggers are generated by the ATP System, Cameras, RFID Readers, Access Control Systems, Special Bands, and various Support Information Systems (University Sub-Systems). A trigger is the information generated upon sensing of the University environment.

Step 2: These triggers are sent to the server (Atiha Grok System).

Step 3: The server analyzes the triggers to map them to events.

Step 4: Finally, the events are used to identify the university related student activities on the University campus.

Note that the above analysis is performed with respect to each student as triggers and events are student-specific. In a particular embodiment, this is undertaken at the end of each day as part of the end-of-day processing.

For each Student ID (SID) (1000), the following are performed to identify the activities of the students.

Obtain Event <ATP,M,TV01> and/or Event <ATP,C,TV01> (1002). Note that these events need to be correlated based on the TS and wherever appropriate, LS. Extract Meeting Request, and extract other participants' information from the obtained event(s) (1002A). Also, get Location and Mode of the ATP System. Note that the ATP System is the one that is associated with Student under processing. Here, the location is the location of the ATP System at the time of trigger. Get Location from ATP based on TS and if possible, verify (1002B). Identify and store the identified activity A01 information. Note that ATP system continuously tracks the location information and updates. In a particular embodiment, the ATP System interacts with the fixed infrastructure using a low-range wireless communication and sets its location based on the location information stored in the fixed infrastructure.

Obtain Event <ACC,S,TV01>, Event <ATP,I,TV01>, Event <CAM,I,TV02>, and/or Event <ATP,F,TV01> (1004). If the location is Cafeteria or Auditorium, verify based on the event <CAM,I,TV02> information (1004A). If the location is Study-room, verify based on the event <ATP,I,TV01> information. If the location is Faculty-room, verify based on information such as greetings contained in the event <ATP,V,TV01>. Obtain the mode of the ATP System. Get Location from ATP based on TS and Verify (1004B). Identify and store the identified activity A02 information. Obtain event <ATP,V,TV01/02>, event <ATP,R/W,TV02>, and/or event <ATP,I,TV01> (1006). Get Location and Mode of the ATP System. The location is either Classroom, Cafeteria, Library, Study-room, Auditorium, or Faculty-room (1006A). Gesture analysis is used to detect the attention factor of the student during the discussion. Get Location from ATP based on TS and Verify (1006B). Identify and store the identified A03 information.

Obtain event <ATP,V,TV01/02>, event <ATP,R/W,TV02>, event <ATP,I,TV01>, and/or event <ATP,F,TV01> (1008). The location is either Classroom or Lab (1008A). Gesture analysis is used to detect the attention factor of the student during the discussion. Obtain Mode of the ATP System. Get Location from ATP based on TS and Verify (1008B). Identify and store the identified A04 information.

Obtain event <ATP,F,TV01> (1010). The location is Study-room (1010A). Obtain Mode of the ATP System. Identify and store the identified A05 information.

Obtain event <CAM,I,TV01>, and/or event <ATP,I,TV01> (1012). The location is Classroom, Lab, or Sports-field (1012A). Gesture Analysis is performed. Obtain Mode of the ATP System. Get Location from ATP based on TS and Verify (1012B). Identify and store the identified A06 information.

FIG. 10A provides the detection possible activities based on additional events.

Obtain event <CAM,I,TV02> and/or event <ATP,I,TV01> (1020). The location is Classroom (1020A). Gesture Analysis is performed. Obtain Mode of the ATP System. Get Location from ATP based on TS and Verify (1020). Identify and store the identified A07 information.

Obtain event <CAM,I,TV01> (1022). The location is Classroom (1022A). Gesture Analysis is performed. Obtain Mode of the ATP System. Get Location from ATP based on TS and Verify (1022B). Identify and store the identified A08 information.

Obtain event <CAM,I,TV01> (1024). The location is Classroom (1024A). Gesture Analysis is performed. Obtain Mode of the ATP System. Get Location from ATP based on TS and Verify (1024B). Identify and store the identified A09 information.

Obtain event <ATP,L,TV01> and/or event <XIS,L,TV01> (1026). The location is Lab, Auditorium, Social-activity-location, or Sports-field (1026A). The log Data contains Collected Material. Obtain Mode of the ATP System. Get Location from ATP based on TS and Verify (1026B). Identify and store the identified A10 information.

Obtain event <ATP,F,TV01>, event <ATP,R/W,TV01>, and/or event <XIS,L,TV06> (1028). The location is Lab (1028A). The log data contains lab usage information. Obtain Mode of the ATP System. Get Location from ATP based on TS and Verify (1028B). Identify and store the identified A11 information.

Obtain event <CAM,I,TV02> and/or event <ATP,I,TV01> (1030). The location is Lab (1030A). Gesture analysis is performed. Obtain Mode of the ATP System. Get Location from ATP based on TS and Verify (1030B). Identify and store the identified A12 information.

Obtain event <ATP,L,TV01> and/or event <XIS,L,TV01> (1032). The location is Lab, Auditorium, Social-activity-Location, or Sports-Field (1032A). The log data contains Returned Material information. Obtain Mode of the ATP System. Get Location from ATP based on TS and Verify (1032B). Identify and store the identified A13 information.

Obtain event <ATP,F,TV01> and/or event <ATP,R,TV01> (1034). The location is Conference-room or Classroom with presentation document opened on Tablet (ATP System) (1034A). Obtain Mode of the ATP System. Get Location from ATP based on TS and Verify (1034B). Identify and store the identified A14 information.

FIG. 10B provides the detection of possible activities based on some more events.

Obtain event <ATP,R,TV01>, event <ATP,V,TV01/02>, event <ATP,F,TV01>, and/or event <CAM,I,TV01> (1042). The location is Conference-room or Classroom (1042A). Gesture analysis is performed. Emotional analysis is performed. Obtain Mode of the ATP System. Get Location from ATP based on TS and Verify (1042B). Identify and store the identified A15 information.

Obtain event <CAM,I,TV01/02> (1044). The location is Conference-room or Classroom (1044A). Perform gesture analysis. Obtain Mode of the ATP System. Get Location from ATP based on TS and Verify (1044B). Identify and store the identified A16 information.

Obtain event <XIS,L,TV04> (1046). The location is Department (1046A). Obtain Mode of the ATP System. Get Location from ATP based on TS and Verify (1046B). Identify and store the identified A17 information.

Obtain event <ATP,F,TV01> and/or event <XIS,L,TV07> (1048). The location is Library (1048A). Obtain Mode of the ATP System. Get Location from ATP based on TS and Verify (1048B). Identify and store the identified A18 information.

Obtain event <ATP,F,TV01> and/or event <ATP,R,TV01> (1050). The location is Library (1050A).

Obtain Mode of the ATP System. Get Location from ATP based on TS and Verify (1050B). Identify and store the identified A19 information.

Obtain event <ATP,F,TV01> and/or event <ATP,R,TV01> (1052). The location is Library (1052A).

Obtain Mode of the ATP System. Get Location from ATP based on TS and Verify (1052B). Identify and store the identified A20 information.

Obtain event <ATP,F,TV01> and/or event <ATP,R,TV01> (1054). The location is Library or Study-room (1054A);). Obtain Mode of the ATP System. Get Location from ATP based on TS and Verify (1054B). Identify and store the identified A21 information.

Obtain event <XIS,L,TV07> (1056). The location is Library (1056A). Obtain Mode of the ATP System. Get Location from ATP based on TS and Verify (1056B). Identify and store the identified A22 information.

FIG. 10C provides the detection of possible activities based on some additional events.

Obtain event <ATP,M,TV02> (1070) in any location (1070A). Obtain Mode of the ATP System. Get Location from ATP based on TS and Verify (1070B). Identify and store the identified A23 information.

Obtain event <ATP,M,TV01> and/or event <ATP,X,TV01> (1072) in any location (1072A). Obtain Mode of the ATP System. Get Location from ATP based on TS and Verify (1072B). Identify and store the identified A24 information.

Obtain event <ATP,V,TV01/02>, event <CAM,I,TV02>, and/or event <XIS,L,TV02> (1074). The location is Auditorium, Sports-field, or Social-activity-location (1074A). Obtain Mode of the ATP System. Get Location from ATP based on TS and Verify (1074B). Identify and store the identified A25 information. Obtain event <ATP,I,TV01>, event <ATP,L,TV01>, and/or event <XIS,L,TV03> (1076). The location is Auditorium, Sports-field, or Social-activity-location (1076A). Obtain Mode of the ATP System. Get Location from ATP based on TS and Verify (1076B). Identify and store the identified A26 information.

Obtain event <ATP,L,TV01>, event <SPB,P,TV02>, event <CAM,I,TV02>, and/or event <XIS,L,TV05> (1078). The location is Auditorium, Sports-field, or Social-activity-location (1078A). Obtain Mode of the ATP System. Get Location from ATP based on TS and Verify (1078B). Identify and store the identified A27 information.

Thus, a system and method for student activity gathering in a university is disclosed. Although the present invention has been described particularly with reference to the figures, it will be apparent to one of the ordinary skill in the art that the present invention may appear in any number of systems that provide for gathering of activities based on events and triggers. It is further contemplated that many changes and modifications may be made by one of ordinary skill in the art without departing from the spirit and scope of the present invention.

We claim:

1. A System for automatically gathering a plurality of activities of a student of a university in a plurality of locations related to said university based on a plurality of triggers, a plurality of events, a plurality of active components, and a plurality of support information systems,
said plurality of activities being related to said university,
said plurality of locations comprising an auditorium, a cafeteria, a classroom, a conference-room, a department, a faculty-room, a lab, a library, a social-activity-location, a sports-field, and a study-room,
said plurality of active components comprising an any tablet phone (ATP), a plurality of radio frequency identifier (RFID) readers, a plurality of cameras, a plurality of access card readers, a plurality of special bands, and a plurality of RFID tags, wherein said any tablet phone is associated with said student and comprising
a Student Voice Capture and Processing Sub-System for customized processing of voice data of said student,
a Student Image Capture and Processing Sub-System for customized processing of facial expression data of said student,
a Student Script Capture and Processing Sub-System for customized processing of handwritten data of said student,
a Student Text Processing Sub-System for processing of textual data associated with said student,
a Tag Processing Sub-System,
a Student-Specific Collaborating Sub-System,
a Student Interactivity Monitoring Sub-System, and
an ATP Logging Sub-System,
said ATP is in one of a plurality of modes, wherein said plurality of modes comprising a curricular mode, a co-curricular mode, and an extra-curricular mode, and
said plurality of support information systems comprising
a University Voice Sub-System,
a University Email Sub-System,
a University Messaging Sub-System,
a University Chat Sub-System,
a University Blog Sub-System,
a University Collaboration Sub-System,
a University Department Sub-System,
a University Library Sub-System,
a University Lab Sub-System,
a University Sports Sub-System,
a University Cultural Sub-System, and
a University Social Sub-System,
said system comprises
a Generator (420) for generating of said plurality of triggers based on said plurality of active components and said plurality of support information systems;
an Event Determining Sub-System (484) for determining of said plurality of events based on said plurality of triggers; and
an Activity Identification Sub-System (486) for identifying of said plurality of activities based on said plurality of events.

2. The system of claim 1 wherein said Generator (420) further comprises of:
a trigger generator (712) for generating a trigger of said plurality of triggers based on the detected voice activity using said any tablet phone;
a trigger generator (714) for generating a trigger of said plurality of triggers based on the detected network activity using said any table phone;
a trigger generator (716) for generating a trigger of said plurality of triggers based on the detected reading activity using said any tablet phone;
a trigger generator (718) for generating a trigger of said plurality of triggers based on the detected writing activity using said any tablet phone;
a trigger generator (720) for generating a trigger of said plurality of triggers based on a textual data during the sending of a message by said student using said any tablet phone;
a trigger generator (722) for generating a trigger of said plurality of triggers based on a textual data during the receiving of a message by said student using said any table phone;
a trigger generator (724) for generating a trigger of said plurality of triggers based on the detected blogging activity using said any tablet phone;
a trigger generator (726) for generating a trigger of said plurality of triggers based on the detected camera activity using said any tablet phone;
a trigger generator (728) for generating a trigger of said plurality of triggers based on the detected collaborative activity using said any tablet phone;
a trigger generator (730) for generating a trigger of said plurality of triggers based on sensing by an RFID reader of said any tablet phone;
a trigger generator (732) for generating a trigger of said plurality of triggers based on the detected calendar activity using said any tablet phone;
a trigger generator (734) for generating a trigger of said plurality of triggers based on the detected logging using said any tablet phone; and
a trigger generator (736) for generating a trigger of said plurality of triggers based on the detected interaction activity using said any tablet phone.

3. The system of claim 2, wherein said means further comprises of:
a trigger generator (750) for generating a trigger of said plurality of triggers based on an image captured by a camera of said plurality of cameras;
a trigger generator (752) for generating a trigger of said plurality of triggers based on an access card data read by an access card reader of said plurality of access card readers;
a trigger generator (754) for generating a trigger of said plurality of triggers based on an RFID tag sensed by an RFID reader of said plurality of RFID readers;
a trigger generator (756) for generating a trigger of said plurality of triggers based on the sensing of data in a special band of said plurality of special bands; and
a trigger generator (758) for generating a trigger of said plurality of triggers based on the logging by a support information system of said plurality of support information systems.

4. The system of claim 1, wherein said Event Determining Sub-System (484) further comprises of:
an ATP-Microphone Event Determiner (805-805E) for determining an event of said plurality of events based on a captured voice data associated with a trigger of said plurality of triggers, a plurality of keywords, a location of said student, and a mode of said plurality of modes, of said any tablet phone, wherein a keyword of said plurality of keywords is recognized using said Student Voice Capture and Processing Sub-System, and said captured voice data;
an ATP-Voice Event Determiner (805B-810E) for determining an event of said plurality of events based on a captured voice data associated with a trigger of said plurality of triggers, a plurality of emotion indicators, and a location of said student, and a mode of said plurality of modes, of said any tablet phone, wherein an emotion indicator of said plurality of emotion indicators is recognized using said Student Voice Capture and Processing Sub-System, and said captured voice data;
an ATP-Voice Call Event Determiner (810-810E) for determining of an event of said plurality of events based on a captured voice call data associated with a trigger of said plurality of triggers, a plurality of keywords, a location of said student, and a mode of said plurality of modes, of said any tablet phone, wherein said trigger is related to a voice call being made by said student, a keyword of said plurality of keywords is recognized using said Student Voice Capture and Processing Sub-System, and said captured voice call data;
an ATP-Voice Call Event Determiner (810-810E) for determining of an event of said plurality of events based on a captured voice call data associated with a trigger of said plurality of triggers, a plurality of keywords, a location of said student, and a mode of said plurality of modes, of said any tablet phone, wherein said trigger is related to a voice call being received by said student, a keyword of said plurality of keywords is recognized using said Student Voice Capture and Processing Sub-System, and said captured voice data;
an ATP-Camera Event Determiner (800-800E) for determining an event of said plurality of events based on a captured image associated with a trigger of said plurality of triggers, a plurality of gesture indicators, a location of said student, and a mode of said plurality of modes, of said any tablet phone, wherein a gesture indicator of said plurality of gesture indicators is recognized using Student Image Capture and Processing Sub System, and said captured image;
an ATP-Message Event Determiner (815-815E) for determining an event of said plurality of events based on a textual data associated with a trigger of said plurality of triggers, a plurality of emotion indicators, a location of said student, and a mode of said plurality of modes, of said any tablet phone, wherein said trigger is related to a message being sent or received by said student, an emotion indicator of said plurality of emotion indicators is recognized using said Student Text Processing Sub-System, and said textual data;
an ATP-Voice Event Determiner (810B-815E) for determining an event of said plurality of events based on a textual data associated with a trigger of said plurality of triggers, a plurality of emotion indicators, a location of said student, and a mode of said plurality of modes, of said any tablet phone, wherein said textual data is based on a voice data associated with said trigger, an emotion indicator of said plurality of emotion indicators is recognized using said Student Text Processing Sub-System, and said textual data;
an ATP-Collaboration Event Determiner (820-820E) for determining an event of said plurality of events based on a textual data associated with a trigger of said plurality of triggers, a plurality of emotion indicators, location of said student, and a mode of said plurality of modes, of said any tablet phone, wherein said textual data is based on a captured whiteboard data associated with said trigger, an emotion indicator of said plurality of emotion indicators is recognized using said Student Script Capture and Processing Sub-System, said captured whiteboard data, and said textual data;
an ATP-RFID Event Determiner (830-830E) for determining an event of said plurality of events based on an RFID data associated with a trigger of said plurality of triggers, a location of said student, and a mode of said plurality of modes, of said any tablet phone, wherein said RFID data is based on the data obtained by an RFID reader of said any tablet phone from the neighborhood RFID tags of said plurality of RFID tags;
an ATP-Network Event Determiner (835-835D) for determining an event of said plurality of events based on a network data during a network access associated with a trigger of said plurality of triggers, a location of said student, and a mode of said plurality of modes, of said any tablet phone, wherein said network access data comprises of a universal resource locator, and a duration of said network access;
an ATP-Reading Event Determiner (840-840E) for determining an event of said plurality of events based on a read data during a reading session associated with a trigger of said plurality of triggers, a location of said student, and a mode of said plurality of modes, of said any tablet phone, wherein said read data is based on the reading of an book by said student, and a duration of said reading session;
an ATP-Writing Event Determiner (845-845E) for determining an event of said plurality of events based on a write data during a writing session associated with a trigger of said plurality of triggers, a location of said student, and a mode of said plurality of modes, of said any tablet phone, wherein said write data is based on the writing by said student, and a duration of said writing session; and
an ATP-Blogging Event Determiner (850-850E) for determining an event of said plurality of events based on a blog data during a blogging session associated with a trigger of said plurality of triggers, a location of said student, and a mode of said plurality of modes, of said any tablet phone, wherein said blog data is based on the blogging by said student, and a duration of said blogging session.

5. The system of claim 4, wherein said sub-system further comprises of:
a Camera Event Determiner (860-860D) for determining an event of said plurality of events based on a changed image captured by a camera of said plurality of cameras associated with a trigger of said plurality of triggers, and a location of said camera;
an RFID Event Determiner (865-865D) for determining an event of said plurality of events based on an RFID data sensed by an RFID reader of said plurality of RFID readers associated with a trigger of said plurality of triggers, and a location of said RFID reader, wherein said RFID data is based on the sensing of the RFID tags, of said plurality of RFID tags, of the neighborhood objects with respect to said RFID reader;
a Special Band Event Determiner (870-870D) for determining an event of said plurality of events based on a special band data associated with a trigger of said plurality of triggers, a location of said student, a mode of said plurality of modes, of said any tablet phone, wherein said special band data is read from a special band reader of said plurality of special band readers by said any tablet phone;
an Access Card Event Determiner (875-875D) for determining an event of said plurality of events based on an access card data read by an access card reader of said plurality of access card readers associated with a trigger of said plurality of triggers, and a location of said access card reader; and
a Log Event Determiner (880-880D) for determining an event of said plurality of events based on a log data associated with a trigger of said plurality of triggers, wherein said log data is the data logged by a support information system of said plurality of support information systems or said ATP Logging Sub-System.

6. The system of claim 1, wherein said Activity Identification Sub-System (486) further comprises of:
a Determiner (1002) for determining of a messaging event of a plurality of similar events associated with said any tablet phone;
a Determiner (1002) for determining of a calendar event of said plurality of similar events associated with said any tablet phone;
a Determiner (1002A) for extracting of a meeting request from said plurality of similar events;
a Determiner (1002A) for extracting of a plurality of participants of said meeting request based on said plurality of similar events;
a Determiner (1002A) for determining of a location based on said plurality of similar events;
a Determiner (1002A) for determining of a mode of said plurality of modes of said any tablet phone based on said plurality of similar events;
a Determiner (1002B) for determining of a time stamp associated with meeting request;
a Determiner (1002B) for determining of a location 1 based on said any tablet phone and said time stamp;
a Determiner (1002B) for comparing of said location and said location 1; and
a Determiner (1002B) for forming of an activity of said plurality of activities based on said mode, said location, and said meeting request 1.

7. The system of claim 6, wherein said sub-system (486) further comprises of:
a Determiner (1004) for determining of a camera event of a plurality of similar events associated with said any tablet phone;
a Determiner (1004) for determining of an RFID event of said plurality of similar events associated with said any tablet phone;
a Determiner (1004) for determining of a camera event 1 of said plurality of similar events associated with a camera of said plurality of cameras;
a Determiner (1004) for determining of an access card event of said plurality of similar events associated with an access card reader of said plurality of access card readers;
a Determiner (1004A) for determining of a voice event of said plurality of similar events associated with said any tablet phone;
a Determiner (1004A) for determining of a location 1 of a plurality of similar locations based on said plurality of similarity events and a facial image of said camera event 1, wherein said location is a cafeteria of said plurality of locations or an auditorium of said plurality of locations and said facial image is that of said student;
a Determiner (1004A) for determining of a location 2 of said plurality of similar locations based on said plurality of similarity events, wherein said location 2 is a study-room of said plurality of locations;
a Determiner (1004A) for determining of a location 3 of said plurality of similar locations based on said plurality of similarity events and a voice data of said voice event, wherein said location 3 is a faculty-room of said plurality of locations and said voice data is that of said student;
a Determiner (1004B) for determining of a time stamp based on said plurality of similar events;
a Determiner (1004B) for determining of a location 4 based on said any tablet phone and said time stamp;
a Determiner (1004B) for comparing of said location 4 and said plurality of similar locations;
a Determiner for determining of a mode of said plurality of modes of said any tablet phone based on said plurality of similar events; and
a Determiner (1004B) for forming of an activity of said plurality of activities based on said mode, said plurality of similar locations, and said plurality of similar events.

8. The system of claim 6, wherein said sub-system (486) further comprises of:
a Determiner (1006) for determining of a voice event of a plurality of similar events associated with said any tablet phone;
a Determiner (1006) for determining of a read event of said plurality of similar events associated with said any tablet phone;
a Determiner (1006) for determining of a write event of said plurality of similar events associated with said any tablet phone;
a Determiner (1006) for determining of a camera event of said plurality of similar events associated with said any tablet phone;
a Determiner (1006A) for determining of a location based on said plurality of similarity events, wherein said location is a classroom of said plurality of locations, a cafeteria of said plurality of locations, a library of said plurality of locations, a study-room of said plurality of locations, an auditorium of said plurality of locations, or a faculty-room of said plurality of locations;
a Determiner (1006A) for performing of a gesture analysis on a face image of said camera event to result in a plurality of gesture indicators, wherein said face image is that of said student;
a Determiner (1006A) for determining of a voice data of said voice event, wherein said voice data is that of said student;
a Determiner (1006B) for determining of a time stamp based on said plurality of similar events;
a Determiner (1006B) for determining of a location 1 based on said any tablet phone and said time stamp;
a Determiner (1006B) for comparing of said location and said location 1;
a Determiner (1006B) for determining of a mode of said plurality of modes of said any tablet phone based on said plurality of similar events; and
a Determiner (1006B) for forming of an activity of said plurality of activities based on said mode, said location, said plurality of gesture indicators, and said plurality of similar events.

9. The system of claim 6, wherein said sub-system (486) further comprises of:
a Determiner (1008) for determining of a voice event of a plurality of similar events associated with said any tablet phone;
a Determiner (1008) for determining of a read event of said plurality of similar events associated with said any tablet phone;
a Determiner (1008) for determining of a write event of said plurality of similar events associated with said any tablet phone;
a Determiner (1008) for determining of a camera event of said plurality of similar events associated with said any tablet phone;
a Determiner (1008) for determining of an RFID event of said plurality of similar events associated with said any tablet phone;
a Determiner (1008A) for determining of a location 1 based on said plurality of similarity events, wherein said location is a classroom of said plurality of locations or a lab of said plurality of locations;
a Determiner (1008A) for performing of a gesture analysis on a face image of said camera event to result in a plurality of gesture indicators;
a Determiner (1008A) for determining of a voice data based on said voice event, wherein said voice data is that of said student;
a Determiner (1008B) for determining of a time stamp based on said plurality of similar events;
a Determiner (1008B) for determining of a location 2 based on said any tablet phone and said time stamp;
a Determiner (1008B) for comparing of said location 1 and said location 2;
a Determiner (1008B) for determining of a mode of said plurality of modes of said any tablet phone based on said plurality of similar events; and
a Determiner (1008B) for forming of an activity of said plurality of activities based on said mode, said location 1, said plurality of gesture indicators, and said plurality of similar events.

10. The system of claim 6, wherein said sub-system (486) further comprises of:
a Determiner (1010) for determining of an RFID event associated with said any tablet phone;
a Determiner (1010A) for determining of a location 1 based on said RFID event, wherein said location is a study-room of said plurality of locations;
a Determiner (1010A) for determining of a mode of said plurality of modes of said any tablet phone based on said RFID event; and
a Determiner (1010B) for forming of an activity of said plurality of activities based on said mode, said location 1, and said RFID event.

11. The system of claim 6, wherein said sub-system (486) further comprises of:
a Determiner (1012) for determining of a camera event of a plurality of similar events associated with said any tablet phone;
a Determiner (1012) for determining of a camera event 1 of said plurality of similar events associated with a camera of said plurality of cameras;
a Determiner (1012A) for determining of a location 1 based on said plurality of similarity events, wherein said location is a classroom of said plurality of locations, a lab of said plurality of locations, or a sports-field of said plurality of locations;
a Determiner (1012A) for performing of a gesture analysis on a face image of said camera event to result in a plurality of gesture indicators;
a Determiner (1012B) for determining of a time stamp based on said plurality of similar events;
a Determiner (1012B) for determining of a location 2 based on said any tablet phone and said time stamp;
a Determiner (1012B) for comparing of said location 1 and said location 2;
a Determiner (1012A) for determining of a mode of said plurality of modes of said any tablet phone based on said plurality of similar events; and
a Determiner (1012B) for forming of an activity of said plurality of activities based on said mode, said location 1, said plurality of gesture indicators, and said plurality of similar events.

12. The system of claim 6, wherein said sub-system (486) further comprises of:
a Determiner (1020) for determining of a camera event of a plurality of similar events associated with said any tablet phone;
a Determiner (1020) for determining of a camera event 1 of said plurality of similar events associated with a camera of said plurality of cameras;
a Determiner (1020A) for determining of a location 1 based on said plurality of similarity events, wherein said location is a classroom of said plurality of locations;
a Determiner (1020A) for performing of a gesture analysis on a face image of said camera event to result in a plurality of gesture indicators;
a Determiner (1020B) for determining of a time stamp based on said plurality of similar events;
a Determiner (1020B) for determining of a location 2 based on said any tablet phone and said time stamp;
a Determiner (1020B) for comparing of said location 1 and said location 2;
a Determiner (1020A) for determining of a mode of said plurality of modes of said any tablet phone based on said plurality of similar events; and
a Determiner (1020B) for forming of an activity of said plurality of activities based on said mode, said location 1, said plurality of gesture indicators, and said plurality of similar events.

13. The system of claim 6, wherein said sub-system (486) further comprises of:
a Determiner (1022, 1024) for determining of a camera event of a plurality of similar events associated with a camera of said plurality of cameras;
a Determiner (1022A, 1024A) for determining of a location 1 based on said plurality of similarity events, wherein said location is a classroom of said plurality of locations;
a Determiner (1022A, (1024A) for performing of a gesture analysis on a face image of said camera event to result in a plurality of gesture indicators;
a Determiner (1022B, 1024B) for determining of a time stamp based on said plurality of similar events;
a Determiner (1022B, 1024B) for determining of a location 2 based on said any tablet phone and said time stamp;
a Determiner (1022B, 1024B) for comparing of said location 1 and said location 2;
a Determiner (1022A, 1024A) for determining of a mode of said plurality of modes of said any tablet phone based on said plurality of similar events; and
a Determiner (1022B, 1024B) for forming of an activity of said plurality of activities based on said mode, said location 1, said plurality of gesture indicators, and said camera event.

14. The system of claim 6, wherein said sub-system (486) further comprises of:
a Determiner (1026) for determining of a log event of a plurality of similar events associated with said any tablet phone;
a Determiner (1026) for determining of an issue log event of said plurality of similar events associated with said University Lab Sub-System, said University Sports Sub-System, said University Cultural Sub-System, or said University Social Sub-System, and said student;
a Determiner (1026A) for determining of a location 1 based on said plurality of similarity events, wherein said location is a lab of said plurality of locations, an auditorium of said plurality of locations, a social-activity-location of said plurality of locations, or a sports-field of said plurality of locations;
a Determiner (1026A) for determining of a collected material based on said plurality of similarity of events;
a Determiner (1026B) for determining of a time stamp based on said plurality of similar events;
a Determiner (1026B) for determining of a location 2 based on said any tablet phone and said time stamp;
a Determiner (1026B) for comparing of said location 1 and said location 2;
a Determiner (1026A) for determining of a mode of said plurality of modes of said any tablet phone based on said plurality of similar events; and
a Determiner (1026B) for forming of an activity of said plurality of activities based on said mode, said location 1, said collected material, and said plurality of similar events.

15. The system of claim 6, wherein said sub-system (486) further comprises of:
a Determiner (1028) for determining of an RFID event of a plurality of similar events associated with said any tablet phone;
a Determiner (1028) for determining of a read event of said plurality of similar events associated with said any tablet phone;
a Determiner (1028) for determining of a write event of said plurality of similar events associated with said any tablet phone;
a Determiner (1028) for determining of a log event of said plurality of similar events associated with said University Lab Sub-System and said student;
a Determiner (1028A) for determining of a location 1 based on said plurality of similarity events, wherein said location is a lab of said plurality of locations;
a Determiner (1028A) for determining of a lab usage data based on said plurality of similarity of events;
a Determiner (1028B) for determining of a time stamp based on said plurality of similar events;
a Determiner for determining of a location 2 based on said any tablet phone and said time stamp;
a Determiner (1028B) for comparing of said location 1 and said location 2;
a Determiner (1028A) for determining of a mode of said plurality of modes of said any tablet phone based on said plurality of similar events; and
a Determiner (1028B) for forming of an activity of said plurality of activities based on said mode, said location 1, said lab usage data, and said plurality of similar events.

16. The system of claim 6, wherein said sub-system (486) further comprises of:
a Determiner (1030) for determining of a camera event of a plurality of similar events associated with a camera of said plurality of cameras;
a Determiner (1030) for determining of a camera event 1 of said plurality of similar events associated with said any tablet phone;
a Determiner (1030A) for performing of a gesture analysis based on plurality of similar events resulting is a plurality of gesture indicators;
a Determiner (1030A) for determining of a location 1 based on said plurality of similarity events, wherein said location is a lab of said plurality of locations;
a Determiner (1030B) for determining of a time stamp based on said plurality of similar events;
a Determiner (1030B) for determining of a location 2 based on said any tablet phone and said time stamp;
a Determiner (1030B) for comparing of said location 1 and said location 2;
a Determiner (1030A) for determining of a mode of said plurality of modes of said any tablet phone based on said plurality of similar events; and
a Determiner (1030B) for forming of an activity of said plurality of activities based on said mode, said location 1, said plurality of gesture indicators, and said plurality of similar events.

17. The system of claim 6, wherein said sub-system (486) further comprises of:
a Determiner (1032) for determining of a log event of a plurality of similar events associated with said any tablet phone;
a Determiner (1032) for determining of an issue log event of said plurality of similar events associated with said University Lab Sub-System, said University Sports Sub-System, said University Cultural Sub-System, or said University Social Sub-System, and said student;
a Determiner (1032A) for determining of a location 1 based on said plurality of similarity events, wherein said location is a lab of said plurality of locations, an auditorium of said plurality of locations, a social-activity-location of said plurality of locations, or a sports-field of said plurality of locations;
a Determiner (1032A) for determining of a returned material based on said plurality of similarity of events;
a Determiner (1032B) for determining of a time stamp based on said plurality of similar events;
a Determiner for determining of a location 2 based on said any tablet phone and said time stamp;
a Determiner (1032B) for comparing of said location 1 and said location 2;
a Determiner (1032A) for determining of a mode of said plurality of modes of said any tablet phone based on said plurality of similar events; and
a Determiner (1032B) for forming of an activity of said plurality of activities based on said mode, said location 1, said returned material, and said plurality of similar events.

18. The system of claim 6, wherein said sub-system (486) further comprises of:
a Determiner (1034) for determining of an RFID event of a plurality of similar events associated with said any tablet phone;
a Determiner (1034) for determining of a read event of said plurality of similar events associated with said any tablet phone;
a Determiner (1034A) for determining of a location 1 based on said plurality of similarity events, wherein said location is a conference room of said plurality of locations or a classroom of said plurality of locations;
a Determiner (1034A) for determining of a presentation document based on said plurality of similarity of events;
a Determiner (1034B) for determining of a time stamp based on said plurality of similar events;
a Determiner (1034B) for determining of a location 2 based on said any tablet phone and said time stamp;
a Determiner (1034B) for comparing of said location 1 and said location 2;
a Determiner (1034A) for determining of a mode of said plurality of modes of said any tablet phone based on said plurality of similar events; and
a Determiner (1034B) for forming of an activity of said plurality of activities based on said mode, said location 1, said presentation document, and said plurality of similar events.

19. The system of claim 6, wherein said sub-system (486) further comprises of:
a Determiner (1042) for determining of an RFID event of a plurality of similar events associated with said any tablet phone;
a Determiner (1042) for determining of a voice event of said plurality of similar events associated with said any tablet phone;
a Determiner(1042) for determining of a read event of said plurality of similar events associated with said any tablet phone;
a Determiner (1042) for determining of a camera event of said plurality of similar events associated with a camera of said plurality of cameras;
a Determiner (1042A) for determining of a location 1 based on said plurality of similarity events, wherein said location is a conference room of said plurality of locations or a classroom of said plurality of locations;
a Determiner (1042A) for performing of a gesture analysis based on said plurality of similar events resulting in a plurality of gesture indicators;
a Determiner (1042A) for performing of an emotional analysis based on said plurality of similar events resulting in a plurality of emotion indicators;
a Determiner (1042B) for determining of a time stamp based on said plurality of similar events;
a Determiner (1042B) for determining of a location 2 based on said any tablet phone and said time stamp;
a Determiner (1042B) for comparing of said location 1 and said location 2;
a Determiner (1042A) for determining of a mode based on said plurality of similar events; and
a Determiner (1042B) for forming of an activity of said plurality of activities based on said mode, said location 1, said plurality of gesture indicators, said plurality of emotion indicators, and said plurality of similar events.

20. The system of claim 6, wherein said sub-system (486) further comprises of:
a Determiner (1044) for determining of a camera event of a plurality of similar events associated with a camera of said plurality of cameras;
a Determiner (1044A) for performing of a gesture analysis based on said plurality of similar events resulting a in a plurality of gesture indicators;
a Determiner (1044A) for determining of a location 1 based on said plurality of similarity events, wherein said location is a conference room of said plurality of locations or a classroom of said plurality of locations;
a Determiner (1044B) for determining of a time stamp based on said plurality of similar events;
a Determiner for determining of a location 2 based on said any tablet phone and said time stamp;
a Determiner (1044B) for comparing of said location 1 and said location 2;
a Determiner (1044A) for determining of a mode of said plurality of modes of said any tablet phone based on said plurality of similar events; and
a Determiner (1044B) for forming of an activity of said plurality of activities based on said mode, said location 1, said plurality of gesture indicators, and said plurality of similar events.

21. The system of claim 6, wherein said sub-system (486) further comprises of:
a Determiner (1046) for determining of a log event of a plurality of similar events associated with said University Department Sub-System;
a Determiner (1046A) for determining of a location 1 based on said plurality of similarity events, wherein said location is a department of said plurality of locations;
a Determiner (1046B) for determining of a time stamp based on said plurality of similar events;
a Determiner (1046B) for determining of a location 2 based on said any tablet phone and said time stamp;
a Determiner (1046B) for comparing of said location 1 and said location 2;
a Determiner (1046A) for determining of a mode of said plurality of modes of said any tablet phone based on said plurality of similar events; and
a Determiner (1046B) for forming of an activity of said plurality of activities based on said mode, said location 1, and said plurality of similar events.

22. The system of claim 6, wherein said sub-system (486) further comprises of:
a Determiner (1048) for determining of an RFID event of a plurality of similar events associated with said any tablet phone;
a Determiner (1048) for determining of a log event of said plurality of similar events associated with said University Library Sub-System;
a Determiner (1048A) for determining of a location 1 based on said plurality of similarity events, wherein said location is a library of said plurality of locations;
a Determiner (1048B) for determining of a time stamp based on said plurality of similar events;
a Determiner (1048B) for determining of a location 2 based on said any tablet phone and said time stamp;
a Determiner (1048B) for comparing of said location 1 and said location 2;
a Determiner (1048A) for determining of a mode of said plurality of modes of said any tablet phone based on said plurality of similar events; and
a Determiner (1048B) for forming of an activity of said plurality of activities based on said mode, said location 1, and said plurality of similar events.

23. The system of claim 6, wherein said sub-system (486) further comprises of:
a Determiner (1050, 1052, 1054) for determining of an RFID event of a plurality of similar events associated with said any tablet phone;
a Determiner (1050, 1052, 1054) for determining of a read event of said plurality of similar events associated with said any tablet phone;
a Determiner (1050A, 1052A, 1054A) for determining of a location 1 based on said plurality of similarity events, wherein said location is a library of said plurality of locations or a study-room of said plurality of locations;
a Determiner (1050B, 1052B, 1054B) for determining of a time stamp based on said plurality of similar events;
a Determiner (1050B, 1052B, 1054B) for determining of a location 2 based on said any tablet phone and said time stamp;
a Determiner (1050B, 1052B, 1054B) for comparing of said location 1 and said location 2;
a Determiner (1050A, 1052A, 1054A) for determining of a mode of said plurality of modes of said any tablet phone based on said plurality of similar events; and
a Determiner (1050B, 1052B, 1054B) for forming of an activity of said plurality of activities based on said mode, said location 1, and said plurality of similar events.

24. The system of claim 6, wherein said sub-system (486) further comprises of:
a Determiner (1056) for determining of a log event of a plurality of similar events associated with said University Library Sub-System;
a Determiner (1056A) for determining of a location 1 based on said plurality of similarity events, wherein said location is a library of said plurality of locations;
a Determiner (1056B) for determining of a time stamp based on said plurality of similar events;
a Determiner (1056B) for determining of a location 2 based on said any tablet phone and said time stamp;
a Determiner (1056B) for comparing of said location 1 and said location 2;
a Determiner (1056A) for determining of a mode of said plurality of modes of said any tablet phone based on said plurality of similar events; and
a Determiner (1056B) for forming of an activity of said plurality of activities based on said mode, said location 1, and said plurality of similar events.

25. The system of claim 6, wherein said sub-system (486) further comprises of:
a Determiner (1070) for determining of a message event of said plurality of similar events associated with said any tablet phone;
a Determiner (1070A) for determining of a location 1 based on said plurality of similarity events, wherein said location is a location of said plurality of locations;
a Determiner (1070B) for determining of a time stamp based on said plurality of similar events;
a Determiner (1070B) for determining of a location 2 based on said any tablet phone and said time stamp;
a Determiner (1070B) for comparing of said location 1 and said location 2;
a Determiner (1070A) for determining of a mode of said plurality of modes of said any tablet phone based on said plurality of similar events; and
a Determiner (1070B) for forming of an activity of said plurality of activities based on said mode, said location 1, and said plurality of similar events.

26. The system of claim 6, wherein said sub-system (486) further comprises of:
a Determiner (1072) for determining of a message event of a plurality of similar events associated with said any tablet phone;
a Determiner (1072) for determining of an interaction event of said plurality of similar events associated with said any tablet phone;
a Determiner (1072A) for determining of a location 1 based on said plurality of similarity events, wherein said location is a location of said plurality of locations;
a Determiner (1072B) for determining of a time stamp based on said plurality of similar events;
a Determiner (1072B) for determining of a location 2 based on said any tablet phone and said time stamp;
a Determiner (1072B) for comparing of said location 1 and said location 2;
a Determiner (1072A) for determining of a mode of said plurality of modes of said any tablet phone based on said plurality of similar events; and
a Determiner (1072B) for forming of an activity of said plurality of activities based on said mode, said location 1, and said plurality of similar events.

27. The system of claim 6, wherein said sub-system (486) further comprises of:
a Determiner (1074) for determining of a voice event of a plurality of similar events associated with said any tablet phone;
a Determiner (1074) for determining of a camera event 1 of said plurality of similar events associated with a camera of said plurality of cameras;
a Determiner (1074) for determining of a log event of said plurality of similar events associated with said University Sports Sub-System, said University Cultural Sub-System, or said University Social Sub-System, and said student;
a Determiner (1074A) for determining of a location 1 based on said plurality of similarity events, wherein said location is an auditorium of said plurality of locations, a sports-field of said plurality of locations, or a social-activity-location of said plurality of locations;
a Determiner (1074B) for determining of a time stamp based on said plurality of similar events;
a Determiner (1074B) for determining of a location 2 based on said any tablet phone and said time stamp;
a Determiner (1074B) for comparing of said location 1 and said location 2;
a Determiner (1074A) for determining of a mode of said plurality of modes of said any tablet phone based on said plurality of similar events; and
a Determiner (1074B) for forming of an activity of said plurality of activities based on said mode, said location 1, and said plurality of similar events.

28. The system of claim 6, wherein said sub-system (486) further comprises of:
a Determiner (1076) for determining of a camera event of a plurality of similar events associated with said any tablet phone;
a Determiner (1076) for determining of a log event of said plurality of similar events associated with said any tablet phone;
a Determiner (1076) for determining of a log event 1 of said plurality of similar events associated with said University Sports Sub-System, said University Cultural Sub-System, or said University Social Sub-System, and said student;
a Determiner (1076A) for determining of a location 1 based on said plurality of similarity events, wherein said location is an auditorium of said plurality of locations, a sports-field of said plurality of locations, or a social-activity-location of said plurality of locations;
a Determiner (1076B) for determining of a time stamp based on said plurality of similar events;
a Determiner (1076B) for determining of a location 2 based on said any tablet phone and said time stamp;
a Determiner (1076B) for comparing of said location 1 and said location 2;
a Determiner (1076A) for determining of a mode of said plurality of modes of said any tablet phone based on said plurality of similar events; and
a Determiner (1076B) for forming of an activity of said plurality of activities based on said mode, said location 1, and said plurality of similar events.

29. The system of claim 6, wherein said sub-system (486) further comprises of:
a Determiner (1078) for determining of a log event of a plurality of similar events associated with said any tablet phone;
a Determiner (1078) for determining of a special band event of said plurality of similar events associated with said any tablet phone;
a Determiner (1078) for determining of a camera event of said plurality of similar events associated with a camera of said plurality of cameras;
a Determiner (1078) for determining of a log event 1 of said plurality of similar events associated with said University Sports Sub-System, said University Cultural Sub-System, or said University Social Sub-System, and said student;
a Determiner (1078A) for determining of a location 1 of a plurality of similar locations based on said plurality of similarity events, wherein said location is an auditorium of said plurality of locations, a sports-field of said plurality of locations, or a social-activity-location of said plurality of locations;
a Determiner (1078B) for determining of a time stamp based on said plurality of similar events;
a Determiner (1078B) for determining of a location 2 based on said any tablet phone and said time stamp;
a Determiner (1078B) for comparing of said location 1 and said location 2;
a Determiner (1078A) for determining of a mode of said plurality of modes of said any tablet phone based on said plurality of similar events; and
a Determiner (1078B) for forming of an activity of said plurality of activities based on said mode, said plurality of similar locations, and said plurality of similar events.
